(19) United States
(12) Patent Application Publication
(10) Pub. No.: US 2014/0061042 A1
(43) Pub. Date: Mar. 6, 2014

(54) ALCOHOL DETECTION DEVICES, APPARATUSES, METHODS, AND COMPUTER PROGRAM PRODUCTS FOR USE IN COMMUNICATION WITH A MOBILE APPLICATION ON A MOBILE DEVICE

(71) Applicant: Alcohoot, LLC, New York, NY (US)

(72) Inventors: Jonathan Ofir, Irvine, CA (US); Noam Navon, Kiryat Tivon (IL); Eldad Yichie, Yokneam Eilit (IL); Ben Biron, Kfar Saba (IL)

(73) Assignee: Alcohoot, LLC, New York, NY (US)

(21) Appl. No.: 14/012,705

(22) Filed: Aug. 28, 2013

Related U.S. Application Data
(60) Provisional application No. 61/695,109, filed on Aug. 30, 2012.

(51) Int. Cl. G01N 27/26

(52) U.S. Cl. CPC G01N 27/26
USPC 204/403.01

(57) ABSTRACT

According to various embodiments, an alcohol detection apparatus is provided for use in conjunction with a mobile application resident on a mobile device. The apparatus comprises: a memory and one or more processors. The one or more processors are configured to: determine whether at least one communication pathway exists between the apparatus and the mobile application resident on the mobile device; responsive to a determination that at least one communication pathway exists, generate an indication that the apparatus is ready to facilitate conducting of at least one blood alcohol content (BAC) level test therewith; capture test data associated with the conduct of at least one BAC level test; and convert the test data into formatted data, the formatted data being suitable for transmission from the apparatus and to the mobile application via the at least one communication pathway. Associated computer-implemented methods and non-transitory computer program products are also provided.

### CROSS-REFERENCE TO RELATED APPLICATIONS

This application claims priority to and the benefit of U.S. Provisional Application No. 61/695,109 filed Aug. 30, 2012, the contents of which are hereby incorporated herein in their entirety by reference.

### BACKGROUND

1. Related Field

Various embodiments of the present invention relate to an alcohol detection device that is configured for convenient use in conjunction with a mobile application loaded on an associated mobile device.

2. Description of Related Art

At present, alcohol detection devices are viewed in a negative light and as such are not commonly used by individuals when attending an event or location where alcohol is being consumed. Beyond cumbersome designs, many portable alcohol detection devices suffer from accuracy deficiencies. Still further, such portable alcohol detection devices fail to provide a convenient and understandable interface with which users may interact. Accordingly, it is desirable to have an alcohol detection device that is easy to use yet accurate in its results, is portable, and is an item that a user thereof will remember to bring with him/her to an event or location where alcohol is being consumed.

### BRIEF SUMMARY

In general, embodiments of the present invention provide methods, apparatus, systems, computing devices, computing entities, and/or the like for an alcohol detection device that is configured for convenient use in conjunction with a mobile application loaded on an associated mobile device.

According to various embodiments, an alcohol detection apparatus is provided for use in conjunction with a mobile application resident on a mobile device. The apparatus comprises: a memory and one or more processors. The one or more processors are configured to: determine whether at least one communication pathway exists between the apparatus and the mobile application resident on the mobile device; responsive to a determination that at least one communication pathway exists, generate an indication that the apparatus is ready to facilitate conducting of at least one blood alcohol content (BAC) level test therewith; capture test data associated with the conduct of at least one BAC level test; and convert the test data into formatted data, the formatted data being suitable for transmission from the apparatus and to the mobile application via the at least one communication pathway.

According to various embodiments, a computer-implemented method for using an alcohol detection apparatus in conjunction with a mobile application resident on a mobile device. The method comprises the steps of: determining, via one or more processors, whether at least one communication pathway exists between the apparatus and the mobile application resident on the mobile device; responsive to a determination that at least one communication pathway exists, activating the apparatus so as to facilitate conducting of at least one blood alcohol content (BAC) level test therewith; capturing, via the one or more processors, test data associated with the conduct of at least one BAC level test; and converting, via the one or more processors, the test data into formatted data, the formatted data being suitable for transmission from the apparatus and to the mobile application via the at least one communication pathway.

According to various embodiments, a non-transitory computer program product is provided comprising at least one computer-readable storage medium having computer-readable program code portions embodied therein. The computer-readable program code portions comprise: an executable portion configured for receiving and storing within one or more memory storage areas one or more algorithms; and an executable portion configured for: determining whether at least one communication pathway exists between the apparatus and the mobile application; and if the at least one communication pathway exists, activating the apparatus so as to facilitate conducting of at least one blood alcohol content (BAC) level test therewith. The computer-readable program code portions further comprise: an executable portion configured for capturing test data associated with the conduct of at least one BAC level test; and an executable portion configured for converting the test data into formatted data, the formatted data being suitable for transmission from the apparatus and to the mobile application via the at least one communication pathway.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram of a system that can be used to practice various embodiments of the present invention;

FIG. 2 is a diagram of a data collection device 30 that may be used in association with certain embodiments of the present invention;

FIG. 3 is a schematic of a central server 10 in accordance with certain embodiments of the present invention;

FIG. 4 is a top left perspective view of an exemplary alcohol detection device 100 according to various embodiments of the present invention;

FIG. 5 is a bottom right perspective view according to various embodiments of the exemplary alcohol detection device 100 of FIG. 4;

FIGS. 6A-B are bottom plan views of the exemplary alcohol detection device 100 of FIG. 4, further illustrating an audio jack 140 and associated slide mechanism 130 in two distinct positions according to various embodiments of the present invention;

FIG. 7 is a front plan view of the exemplary alcohol detection device 100 of FIG. 4, further illustrating various exemplary internal components thereof according to various embodiments of the present invention;

FIG. 8 is a front plan view of the exemplary alcohol detection device 100 of FIG. 4, illustrating still further exemplary internal components thereof according to various embodiments of the present invention;

FIG. 9 is an illustration of an exemplary audio jack 140, as is incorporated within the exemplary alcohol detection device 100 of FIG. 4 according to various embodiments of the present invention;

FIG. 10 is a schematic of a mobile device 200 in accordance with certain embodiments of the present invention;

FIG. 11 illustrates an exemplary mobile application 230, as may be incorporated upon the mobile device 200 of FIG. 10 according to various embodiments of the present invention;

FIGS. 12A-B illustrate an exemplary user operation demonstration, as may be incorporated within the exemplary mobile application 230 of FIG. 11 according to various embodiments of the present invention;

FIGS. 13A-B illustrate exemplary service providing screens 234/236, as may be incorporated within the exemplary mobile application 230 of FIG. 11 according to various embodiments of the present invention;

FIG. 14 illustrates an exemplary user history data display screen 240, as may be incorporated within the exemplary mobile application 230 of FIG. 11 according to various embodiments of the present invention;

FIG. 15 illustrates an exemplary user configuration screen 250, as may be incorporated within the exemplary mobile application 230 of FIG. 11 according to various embodiments of the present invention;

FIG. 16 illustrates an exemplary cable configured for charging the exemplary alcohol detection device 100 of FIG. 4 according to various embodiments of the present invention;

FIG. 17 is a flowchart illustrating operations and processes that can be used in accordance with various embodiments of the present invention; and

FIGS. 18A-B illustrate exemplary Manchester encoding formats for data transmissions between the alcohol detection device 100 of FIG. 4 and the exemplary mobile application 230 of FIG. 11 according to various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Computer Program Products, Methods, and Computing Entities

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations, respectively, may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary Architecture

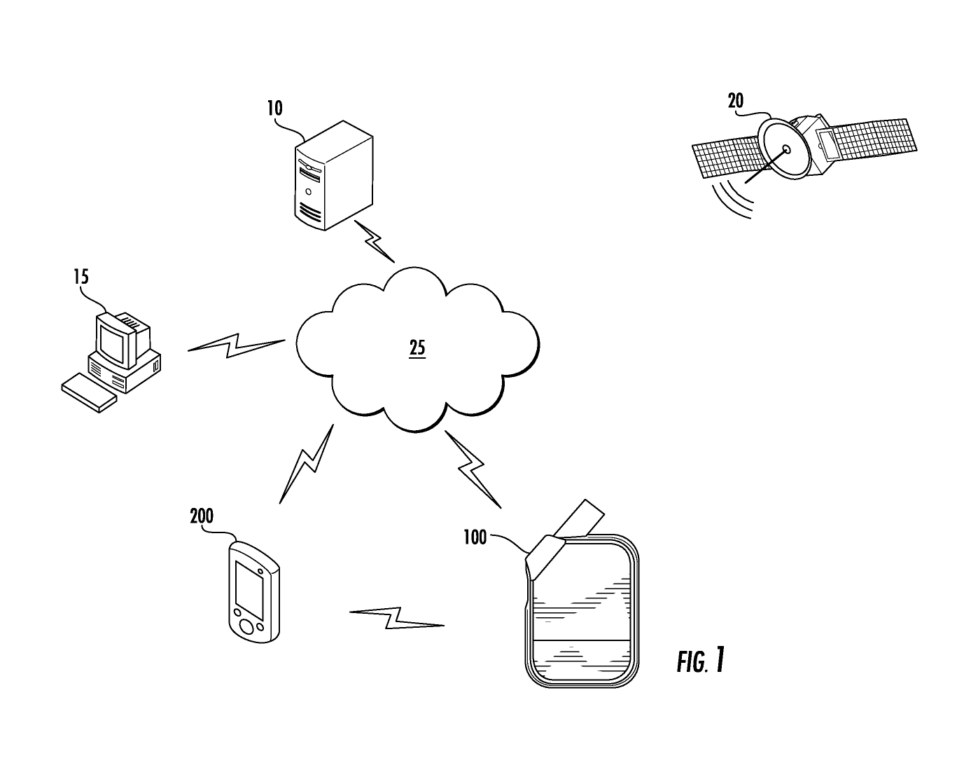

The system may include one or more alcohol detection devices 100, one or more mobile devices 200, one or more central servers 10, one or more centralized computing devices 15, one or more Global Positioning System (GPS) satellites 20, one or more networks 25, and/or the like. Each of these components, entities, devices, systems, and similar words used herein interchangeably may be in direct or indirect communication with, for example, one another over the same, multiple, or different wired or wireless networks. Additionally, while FIG. 1 illustrates the various system entities as separate, standalone entities, the various embodiments are not limited to this particular architecture.

a. Exemplary Central Server 10

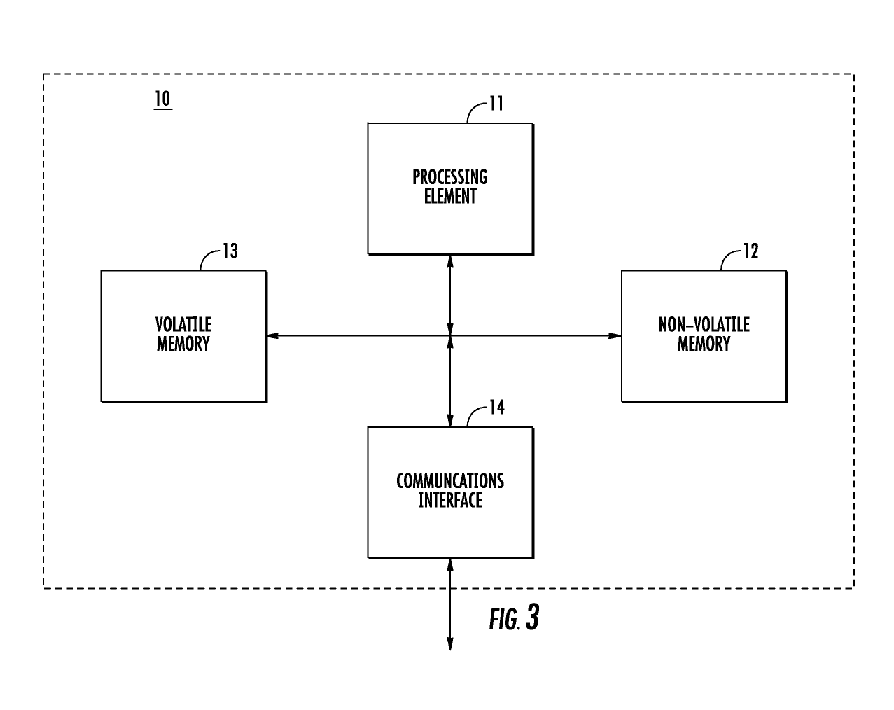

FIG. 3 provides a schematic of an exemplary central server 10 according to various embodiments. In certain embodiments, beyond the one or more mobile devices 200 and one or more alcohol detection devices 100, as will be described in further detail below, one or more central servers 10 may also be provided within the system. In these embodiments, it should be understood that the one or more central servers 10 are configured to provide an additional layer of communication and data handling, where such may be beneficial, for example, beyond personal use of the systems described elsewhere herein. In these and other embodiments, it should also be understood from FIG. 1 that the central server 10 is located geographically remote relative to a location of at least the one or more alcohol detection devices 100 and the one or more mobile devices 200 during operation of the systems described herein. That being said, in still other embodiments, the central server 10 may not necessarily need to be remotely located in this manner.

As a non-limiting example, one or more alcohol detection devices 100 and one or more mobile devices 200 may be provided by a corporate entity (i.e., employer) to one or more employees thereof, such that each employee receives a device and uses the same at certain times, as may be required or requested by the employer. Notably, in the trucking and shipping industry carriers are generally at risk for some degree of liability if their drivers operate vehicles while intoxicated beyond a pre-determined threshold (e.g., by company rules or by jurisdictional laws). As such, the carrier employer may operate a central server 10 to manage and maintain data records for each of its employees. In certain embodiments, the central server 10 may also be associated with one or more centralized computing devices 15, which may be configured, as desirable, so as to access, monitor, and/or analyze the date received by and compiled within the central server 10, as such will be described in further detail below.

Another non-limiting exemplary application arises in the law enforcement context, wherein a law enforcement department or entity may similarly provide one or more alcohol detection devices 100 and one or more mobile devices 200 for its personnel. When such are used in the field, for example during routine traffic stops or otherwise, data accumulated thereby may be transmitted via the one or more networks 25 to the central server 10 for purposes of recordkeeping and/or analysis. Still further applications exists, as should appreciated, whether in the restaurant, bar, or broader commercial vehicle contexts, but it should be understood that those described herein are provided merely for illustration and as such should not be construed as limiting in nature.

With this context, generally speaking, the term server may refer to and/or encompass, as non-limiting examples, one or more computers, computing devices, computing entities, distributed systems, blades, gateways, switches, processing devices, processing entities, relays, routers, network access points, scanners, cameras, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

Returning to FIG. 3, in one embodiment, the central server 10 may include or be in communication with one or more processing elements 11 (also referred to as processors, processing circuitry, and/or similar terms used herein interchangeably) that communicate with other elements within the central server 10 via a bus, for example. As will be understood, the processing element 11 may be embodied in a number of different ways. For example, the processing element 11 may be embodied as one or more complex programmable logic devices (CPLDs), microprocessors, multi-core processors, co-processing entities, application-specific instruction-set processors (ASIPs), microcontrollers, and/or controllers. Further, the processing element 11 may be embodied as one or more other processing devices or circuitry. The term circuitry may refer to an entirely hardware embodiment or a combination of hardware and computer program products. Thus, the processing element 11 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 11 may be configured for a particular use or configured to execute instructions stored in volatile or non-volatile media or otherwise accessible to the processing element 11. As such, whether configured by hardware or computer program products, or by a combination thereof, the processing element 11 may be capable of performing steps or operations according to embodiments of the present invention when configured accordingly.

In one embodiment, the central server 10 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 12 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database mapping systems, data, applications, programs, program modules, scripts, source code, object code, byte code, compiled code, interpreted code, machine code, executable instructions, and/or the like. The term database, database instance, database mapping system, and/or similar terms used herein interchangeably may refer to a structured collection of records or data that is stored in a computer-readable storage medium, such as via a relational database, hierarchical database, and/or network database.

In one embodiment, the central server 10 may further include or be in communication with volatile media (also referred to as volatile storage, memory, memory storage, memory circuitry and/or similar terms used herein interchangeably). In one embodiment, the volatile storage or memory may also include one or more volatile storage or memory media 13 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database mapping systems, data, applications, programs, program modules, scripts, source code, object code, byte code, compiled code, interpreted code, machine code, executable instructions, and/or the like being executed by, for example, the processing element 11. Thus, the databases, database instances, database mapping systems, data, applications, programs, program modules, scripts, source code, object code, byte code, compiled code, interpreted code, machine code, executable instructions, and/or the like may be used to control certain aspects of the operation of the central server 10 with the assistance of the processing element 11 and an operating system.

Remaining with FIG. 3, as indicated, in certain embodiments, the central server 10 may also include one or more communications interfaces 14 for communicating with various computing entities, such as by communicating data, content, information, and/or similar terms used herein interchangeably that can be transmitted, received, operated on, processed, displayed, stored, and/or the like. For instance, the central server 10 may communicate with one or more alcohol detection devices 100, one or more mobile devices 200, one or more centralized computing devices 15, one or more Global Positioning System (GPS) satellites 20, and/or the like.

Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the central server 10 may be configured to communicate via wireless external communication networks using any of a variety of protocols. Such protocols may comprise: 802.11, general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol. Although not shown, the central server 10 may include or be in communication with one or more input elements either directly or via the centralized computing devices 15 described herein. Such input elements may include non-limiting examples such as a keyboard input, a mouse input, a touch screen/display input, audio input, pointing device input, joystick input, keypad input, and/or the like. The central server 10 may also include or be in communication with one or more output elements (not shown), such as audio output, video output, screen/display output, motion output, movement output, and/or the like. Such interfaces may likewise be directly associated with the central server 10 or indirectly linked thereto, for example, via one or more centralized computing devices 15.

As will be appreciated, one or more of the central server 10 components may be located remotely from other central server 10 components, such as in a distributed system. The central server 10 components, or at least a portion thereof as may be desirable, may be further remotely distributed relative to the one or more alcohol detection devices 100 and the one or more mobile devices 200 described elsewhere herein, although it should be understood the geographically remote distribution thereof is not required. Furthermore, one or more of the components may be combined and additional components performing functions described herein may be included in the central server 10. Thus, the central server 10 can be adapted to accommodate a variety of needs and circumstances.

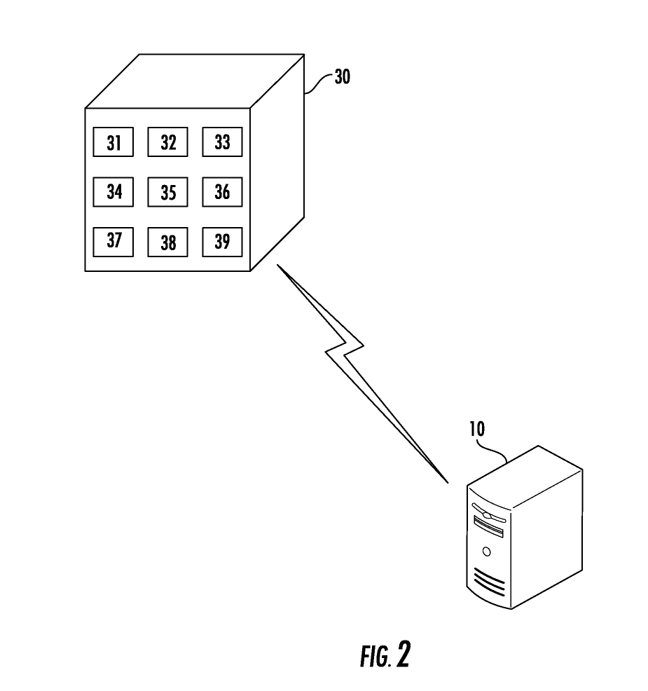

Turning momentarily to FIG. 2, such provides a block diagram of an exemplary data collection device 30 that may be attached, affixed, disposed upon, integrated into, or part of the central server 10. The data collection device 30 may collect various data associated with use of the alcohol detection device 100 and/or the mobile device 200, both as described in further detail below.

In various embodiments, the data collection device 30 may include, be associated with, or be in communication with one or more processors 31, one or more location-determining devices or one or more location sensors 32 (e.g., Global Navigation Satellite System (GNSS) sensors), a J-Bus protocol architecture, one or more electronic control modules (ECM) 33, one or more communication ports 34 for receiving data from various associated devices (e.g., via a CAN-bus), one or more communication ports 35 for transmitting/sending data, one or more power sources 36, one or more data radios 37 for communication with a variety of communication networks, one or more memory modules 38, and one or more programmable logic controllers (PLC) 39. It should be noted that many of these components may be located at the central server 10 but external to the data collection device 30. In still other embodiments, the data collection device 30 and above components may be further remotely located relative to the central server 10, whether for security purposes or otherwise.

In one embodiment, the one or more location sensors 20 may be one of several components in communication with or available to the data collection device 30. Moreover, the one or more location sensors 20 may be compatible with a Low Earth Orbit (LEO) satellite system or a Department of Defense (DOD) satellite system. Alternatively, triangulation may be used in connection with a device associated with a particular vehicle and/or the vehicle's operator and with various communication points (e.g., cellular towers or Wi-Fi access points) positioned at various locations throughout a geographic area to monitor the location of at least one of the mobile device 200, the alcohol detection device 100, and/or its operator. The one or more location sensors 20 may be used to receive latitude, longitude, altitude, position, and time data. The one or more location sensors 20 may also communicate with the central server 10, the data collection device 30, and/or similar computing entities.

As indicated, a communication port 34 may be one of several components available in the data collection device 30 (or be in or as a separate computing entity). Embodiments of the communication port 34 may include an Infrared data Association (IrDA) communication port, a data radio, and/or a serial port. The communication port 34 may receive instructions for the data collection device 30 from a plurality of devices, whether the central server 10 and/or the mobile device 200, as described elsewhere herein. In one embodiment, the data radio 37 may be configured to communicate with a wireless wide area network (WWAN), wireless local area network (WLAN), wireless personal area network (WPAN), or any combination thereof. For example, the data radio 37 may communicate via various wireless protocols, such as 802.11, GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Such communications as described and detailed above may be across the one or more networks 25 of FIG. 1 or otherwise, such that data may be seamlessly and efficiently exchanged between any of a variety of combination of devices within the system. Non-limiting examples include real-time exchanges of data between the alcohol detection device 100 and the mobile device 200, between the mobile device and the central server 10, and between the mobile device and a satellite system 20. Indeed, any of a variety of data exchanges may occur without departing from the scope and intent of the various embodiments described herein.

b. Exemplary Alcohol Detection Device 100

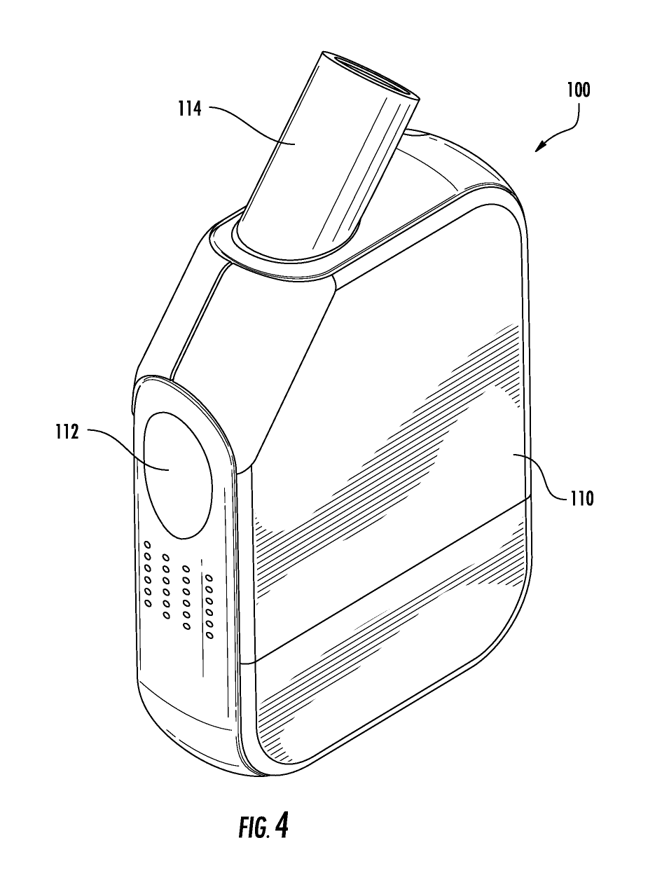

In various embodiments, an alcohol detection device 100 is provided, as illustrated in at least FIGS. 4-9. Generally speaking, three major types of alcohol detection devices 100 exist, namely (1) breathalyzers; (2) intoxilyzers; and (3) alcosensors. Breathalyzers typically use a chemical reaction involving alcohol that produces a color change, while intoxilyzers detect alcohol by IR spectroscopy. Alcosensors, on the other hand, detect a chemical reaction of alcohol in a fuel cell. The alcohol detection device 100 generally referred to and described herein is in certain embodiments an alcosensor. It should be understood, however, that any of the various commonly known and used alcohol detection devices now and as may be at some time in existence may be substituted for such an alcosensor and modified accordingly, as described elsewhere herein. That being said, amongst various benefits, alcosensors are more accurate, alcohol-specific when testing, and have a longer life than the other major types of alcohol detection devices. Historically, other than the alcohol detection device 100 described herein, such alcosensor configured devices have remained significantly more costly than the alternative configurations.

Turning now to FIG. 4 in particular, various external components of the exemplary alcohol detection device 100 described herein are illustrated. According to various embodiments, the alcohol detection device 100 may thus comprise a case or body 110, one or more nozzle openings 112, and mouthpiece 114. In certain embodiments, the case or body may be formed from two or more pieces that may be selectively secured relative to one another so as to contain within a cavity formed therein further internal components, as will be described in further detail below. In other embodiments, it should be understood that the case or body 110 may be formed from a single integral piece of material, where such may be desirable. In still other embodiments, the case or body 100 may be formed from a substantially integral piece of material, but for an opening wherein at least one an audio jack 140 or a battery 156 may be accessible, whether for maintenance or repair thereof or otherwise.

With continued reference to FIG. 4, it may be seen that the case or body 110 is generally according to various embodiments is substantially rectangular in shape. In certain embodiments, the case or body 110 may be substantially square in shape. In other embodiments, the case or body 110 may be any of a variety of shapes, provided such is generally compact and easy for a user to securely hold during use thereof. Although not expressly illustrated, according to various embodiments, the case or body 110 has dimensions of approximately 2.5 inches by 2 inches by ¾ of an inch. In certain embodiments, the dimensions may be otherwise, as selected from a combination of a length in a range of approximately 2 to 4 inches, a width in a range of approximately 1 to 2 inches, and a thickness in a range of approximately ¼ to 1 inch. As mentioned, however, it should be understood that the case or body 110 is generally dimensioned according to various embodiments such that the alcohol detection device 100 is relatively compact so as to, as a non-limiting example, fit in a user's pocket for easy transport and use thereof. In still other embodiments, the alcohol detection device 100 may be substantially otherwise dimensioned, even to the extent such may not be considered relative compact, as described herein. In at least one embodiment, the alcohol detection device 100 may have dimensions of 68.5 millimeters, by 48 millimeters, by 17.5 millimeters. Varying dimensions may be provided, as previously mentioned.

As may also be seen in FIG. 4, one or more nozzle openings 112 and/or a mouthpiece 114 may also be provided with the alcohol detection device 100 according to various embodiments. In certain embodiments, the mouthpiece 114 may be selectively detachable, as may be desirable by one or more users of the device. It should further be understood that the illustrated mouthpiece 114 is exemplary in nature and that any of a variety of mouthpieces of alcohol detection devices (or even other devices) may be substituted therefor, as such are commonly known and configured in the art. Similarly, the one or more nozzle openings 112 are configured with the alcohol detection device 100, as generally commonly known and understood in the art so as to provide a through-passage for airflow during use of the device.

In the illustrated embodiment of the alcohol detection device 100, the one or more nozzle openings 112 are positioned adjacent an upper left-hand corner of the device, although it should be understood that the nozzle openings may be otherwise located, as may be desirable for particular applications. Another non-limiting example incorporates a nozzle opening wholly one side of the device. Still further, although illustrated as substantially circular or oval in shape, the one or more nozzle openings 112 and/or the mouthpiece 114 may have any of a variety of different cross-sectional shapes, as may be desirable for particular applications without departing from the scope and nature of the present invention.

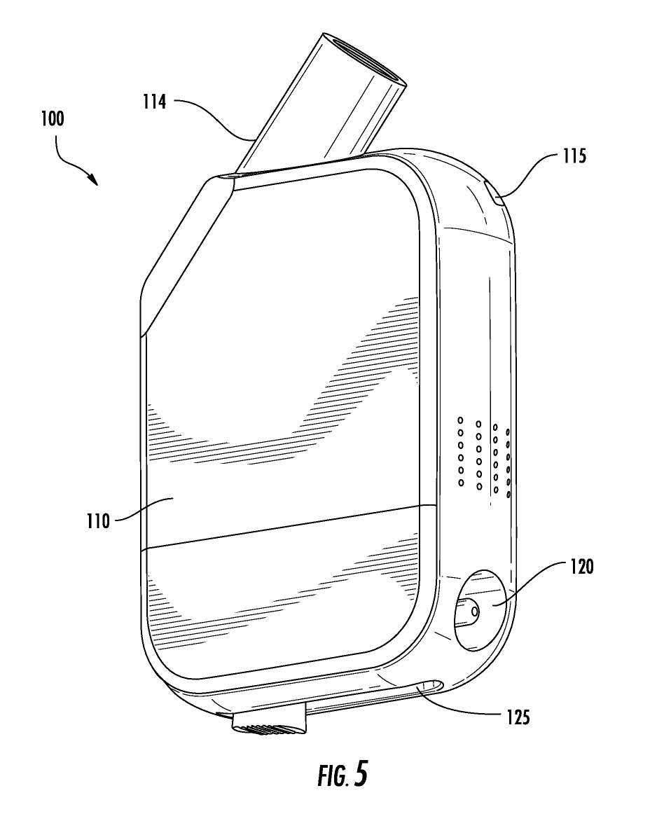

Turning now to FIG. 5, additional external features of the alcohol detection device 100 according to various embodiments are illustrated, namely comprising as formed within the case or body 110 thereof, one or more light emitting diode (LED) indicator openings 115, at least one audio jack receiving opening 120, and at least one elongate slot 125. In certain embodiments, the one or more LED indicator openings 115 are configured such that a visible indicator may be provided thereto to a user, during operation of the device, as will be described in further detail below.

Although not expressly illustrated, at least one of the LED indicator openings may be operatively associated with a physical power button, such that a visible indicator appears when the device 100 is powered-on. In other embodiments, however, as will be described in further detail below, a physical power button may not be provided, with power management being otherwise controlled at least in part by an associated mobile device 200. In still other embodiments, the device 100 may power-on upon detection of airflow through the nozzle opening 112, again as will be described in further detail below.

According to various embodiments, when the alcohol detection device 100 is turned on, but is not connected to the mobile device 200, at least one LED associated with an LED indicator opening may be configured to illuminate a product logo or the like on the device 100. In certain embodiments, when the alcohol detection device 100 is connected to the mobile device 200 and paired successfully therewith, as will be described in further detail below, one or more of the LEDs may be configured to blink twice. In these and other embodiments, after a user commences a test on the alcohol detection device 100, again as will be described in further detail below, at least one LED may be configured to illuminate the mouthpiece 114. In at least one embodiment, the mouthpiece 114 may be configured to remain illuminated until the sampling process concludes; in these and still other embodiments, the LED may be configured to turn off upon completion of the sampling and/or testing process, thereby providing a user of the device 100 a visual indicator of test completion.

Still further, according to various embodiments, when the alcohol detection device 100 is connected to a charger and/or is being charged, both as will be described in further detail below, at least one LED associated with an LED indicator opening may be configured to illuminate one or more features on the body or case 110 of the device. As a non-limiting example, in at least one embodiment, at least one LED may be configured to periodically turn on and off, so as to create a flashing or “breathing affect” from the exterior of the case or body 110. In certain embodiments, the periodic flashing or “breathing affect” may be further associated with a logo imprinted upon the body or case 110. In these and still other embodiments, when the battery is fully charged, again as will be described in further detail below, the at least one LED associated with the charging process may be configured to cease the periodic flashing or “breathing affect” and instead continuously remain on, at least until the device 100 is operatively disconnected from the charger. It should be understood, however, that any of a variety of LEDs, LED indicator openings, and/or the like may be provided upon the body or case 110 of the alcohol detection device 100, as may be desirable for providing certain notifications of information to users thereof, without departing from the scope and nature of the various embodiments described herein.

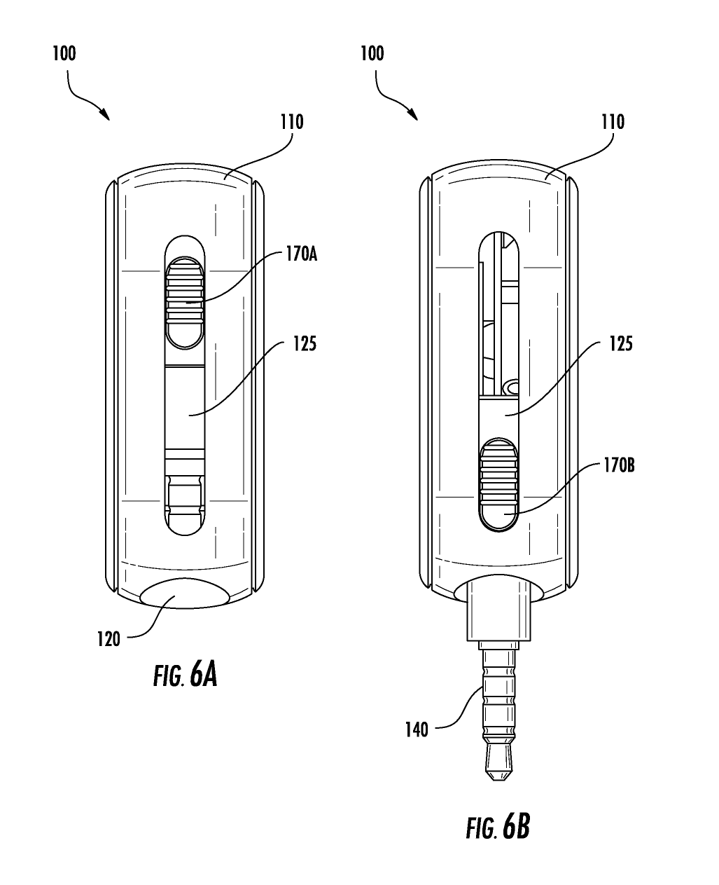

With reference to the at least one audio jack receiving opening 120, the opening is configured according to various embodiments such that an audio jack may be moved there-through, such that the jack 140 is either in an extended orientation (see FIG. 6B and jack 140) or a retracted position (see FIG. 6A). Although illustrated as a substantially circular opening 120, any of a variety of shapes of openings may be incorporated in other embodiments, provided such correspondent substantially to the shape of the associated audio jack 140, so as to not adversely interfere with any relative movement there-between.

With reference to the at least one elongate slot 125 and focusing upon FIGS. 6A-B, according to various embodiments, the slot extends along a majority of a bottom surface of the case or body 110 of the alcohol detection device 100. Of course, in other embodiments, as mentioned, the slot 125 (like the associated opening 120) may be otherwise positioned and oriented, as may be desirable beyond the exemplary illustrated embodiment. Specifically from FIGS. 6A-B, however, it should be understood that a length of the elongate slot 125 corresponds substantially with a length of the audio jack 140 retracted within the opening 120. In this manner, movement of a slide mechanism 170 (described further below) along the elongate slot 125 will result in movement of the audio jack 140 from a retracted (i.e., hidden) orientation 170A (see FIG. 6A) and to an extended (i.e., protruding) orientation 170B (see FIG. 6B), and vice versa. The orientations 170A-B further correspond to positions of a slide tab of the slide mechanism 170, again as will be described in further detail below.

According to various embodiments, the elongate slot 125 of the alcohol detection device 100 has dimensions of approximately 1 inch in length and ½ an inch in width. In certain embodiments, the dimensions may be in a range of approximately ½ to 2 inches in length, and a range of approximately ¼ to ¾ an inch in width. As mentioned, however, it should be understood that the elongate slot 125 is generally dimensioned according to various embodiments such that its length corresponds substantially with a length of an associated audio jack 140 and a width of an associated slide tab of a slide mechanism 170, the latter of which as will be described in further detail below.

Still further, returning momentarily to FIG. 5, although the audio jack receiving opening 120 and the associated elongate slot 125 are provided substantially adjacent a bottom surface of the case or body 110, it should be understood that such may be otherwise positioned on the case or body of the alcohol detection device 100, as may be desirable. However, such differing placement of the opening 120 and/or slot 125 should be in a manner that maintains the compactness and the general outline of the device in its entirety, so as to not adversely impact user transport and use thereof in a convenient manner, as described elsewhere herein.

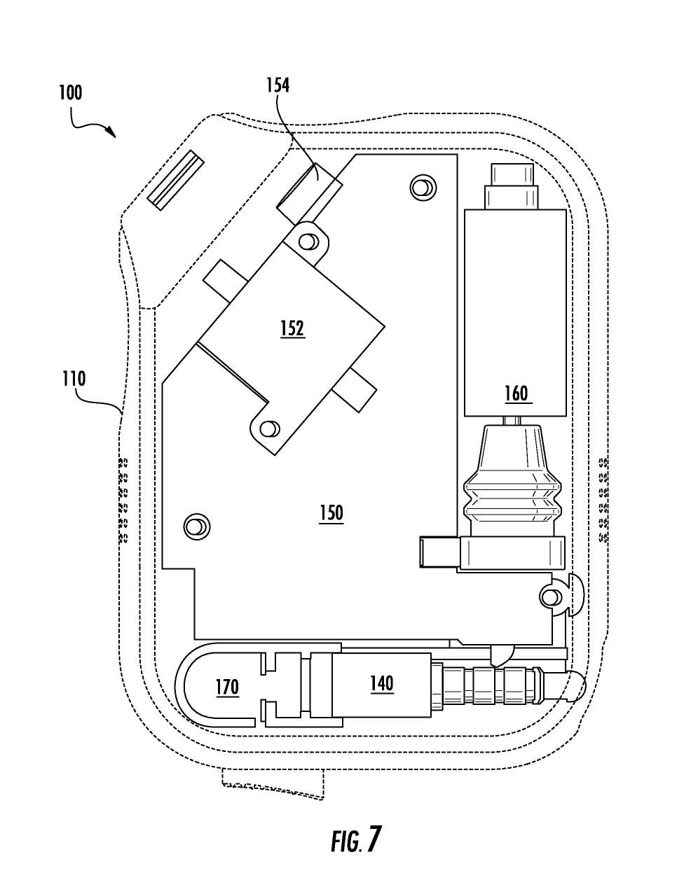

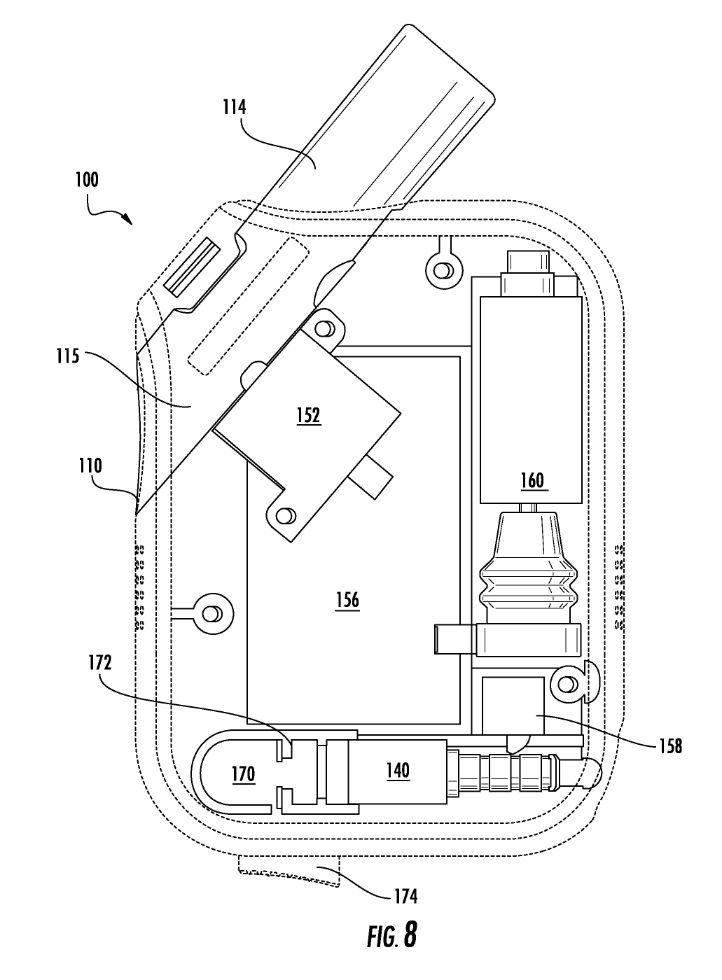

Turning now to FIGS. 7-8, various internal components of the alcohol detection device 100 are illustrated, for purposes primarily of providing a complete and thorough disclosure thereof. Such components, as located according to various embodiments within the alcohol detection device 100, may comprise a printed circuit board (PCB) 150, a fuel cell 152, a sensor 154, a battery 156, a switch 158, a pump mechanism 160, an audio jack 140 (as at least in part previously described herein), and a slide mechanism 170. In certain embodiments, the PCB 150 provides the infrastructure and at least one processing component via which the airflow through the device 100 is processed into a conventionally known and understood blood-alcohol-content (BAC) reading. At least the fuel cell 152, the sensor 154, and the pump mechanism 160, each as will be described in turn are, in at least the illustrated embodiment operatively associated with the PCB 150.

According to various embodiments, the fuel cell 152, as such are commonly known and understood, includes two platinum electrodes (not shown) with a porous acid-electrolyte material (also not shown) sandwiched there-between. As exhaled air from a user of the alcohol detection device 100 blows air past one side of the fuel cell, namely that positioned substantially adjacent the nozzle and nozzle openings 115 (see FIG. 8), the platinum oxidizes any alcohol in the airflow to produce acetic acid, protons, and electrons. The electrons flow through a wire from the platinum electrode, again not specifically illustrated, although described for purposes of illustration of conventional operation of a fuel-cell based alcohol detection device 100. The wire is connected to an electrical-current meter and to the platinum electrode on the other side thereof (also not illustrated). The protons move through a lower portion of the fuel cell and thus combine with oxygen and the electrons so as to form water. The more alcohol that is oxidized, the greater the resultant electrical current; thus, in turn, the greater the electrical current, the higher the BAC reading, generally speaking. One or more processing elements (also referred to as processors, processing circuitry, and/or similar terms used herein interchangeably, such as CPLDs, microprocessors, multi-core processors, co-processing entities, ASIPs, microcontrollers, and/or controllers) within or associated with the PCB 150 measure the value of the electrical current and based at least in part thereon, as also commonly known and understood in the art, calculates the associated BAC reading.

The sensor 154 provided in accordance with various embodiments of the alcohol detection device 100 and illustrated in at least FIG. 7 is, like the fuel cell 152, positioned substantially adjacent at least a portion of the nozzle and/or nozzle opening 115 through which airflow passes. In this manner, the sensor 154, like the fuel cell 152 is configured to assess certain characteristics of the airflow, as it passed thereby. In certain embodiments, the sensor 154 is configured to measure an intensity of the airflow passing thereby, so as to determine whether or not sufficient airflow is passing through the device so as to obtain an accurate and reliable test result. In these embodiments, the sufficiency of the airflow may be determined by any of a variety of parameters, pre-set or otherwise, as may be particular to specific embodiments of the alcohol detection device 100 and the characteristics thereof. In any of these and still other embodiments, an indication of insufficient airflow, whether via an audio or visual alarm or otherwise, generated by the device 100 itself or an associated and operatively connected mobile device 200, may be generated where a parameter is not satisfied. In this manner, the devices 100/200 are configured according to various embodiments so as to minimize the occurrence of erroneous BAC readings.

Alongside the fuel cell 152 and sensor 154 components, a pump mechanism 160 is also provided, as illustrated in FIGS. 7-8. Generally speaking, as is commonly known and understood in the art of alcohol detection devices, the pump mechanism 160 is configured to collect and store the provided breath sample during the processing thereof, as described previously herein. Although not specifically numbered, it may be understood from FIG. 8 that the pump mechanism 160 in at least the illustrated embodiment comprises (viewed from top to bottom) a pump box, a pump extending through the box and appearing substantially there-below, and a pump base. It should be understood, however, that any of a variety of pump mechanisms, alternatively or otherwise configured, may be incorporated within the alcohol detection device 100 without departing from the scope and intent of the present invention.

Still further, as illustrated in FIG. 8, according to various embodiments, a battery 156 is provided within the internal cavity (shown, but not numbered) of the alcohol detection device 100. In certain embodiments, the battery comprises a lithium ion-type battery. Generally speaking, as commonly known and understood in the art, the battery is configured to provide power to the various components of the alcohol detection device 100, as such have been and will be described in further detail elsewhere herein. In certain embodiments, the battery 156 may be configured to be recharged in much the same manner as conventionally known and used alcohol detection devices 100 and/or mobile devices 200, whether via a USB or mini-USB connection port configured to be connected (e.g., via a cable) to a corresponding power outlet and/or power source. In other embodiments, however, the battery 156 may be configured for charging (i.e., recharging) via the audio jack 140, namely via at least one channel thereof, as will be described in further detail below. In such embodiments, a USB, a mini-USB, a micro-USB (or other of a variety of) connection need not be provided further on the body or case 110 of the device 100, as the audio jack 140 itself is configured for providing a charge to and repowering the battery.

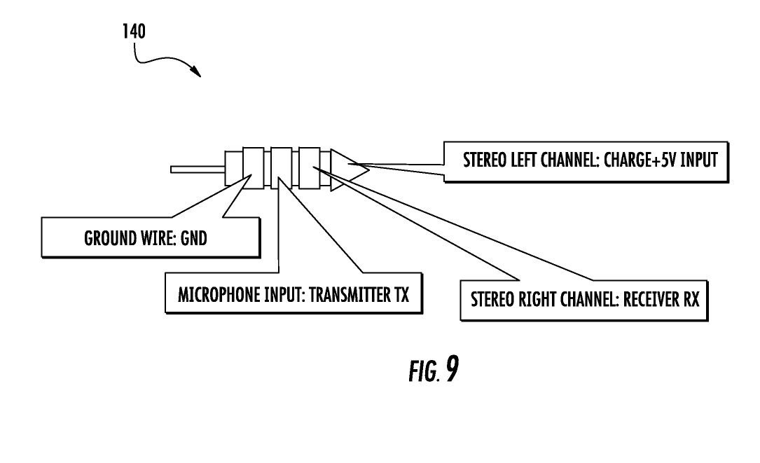

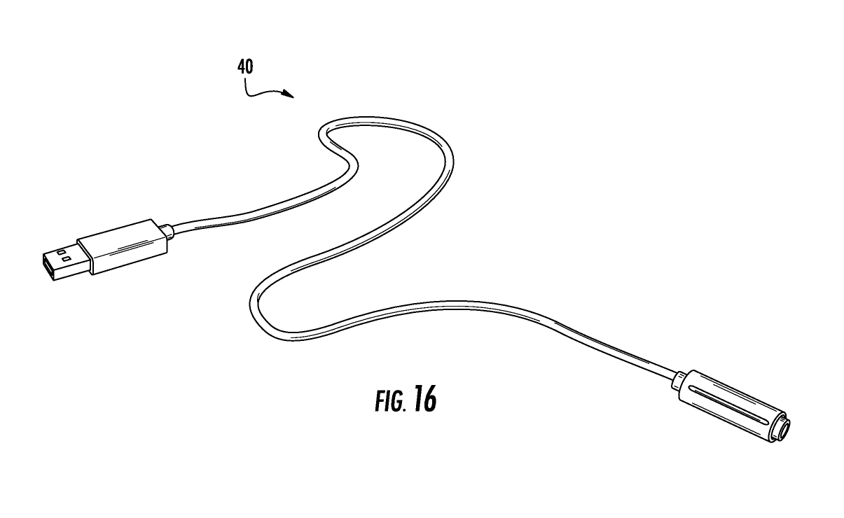

With further emphasis upon the recharging of the alcohol detection device 100 according to various embodiments via the audio jack 140, an exemplary cable 400 for the provision of this capability is illustrated in FIG. 16. As may be seen, one end of the cable is configured to engage with a standard 3.5 mm audio socket, as may be incorporated as the audio jack 140 in certain embodiments and as is illustrated at least in part also in FIG. 9. The opposing end of the cable 400 is configured in at least the illustrated embodiment to engage with a mini-USB port, although, as previously mentioned, any of a variety of power source adaptor plugs may be incorporated on the cable, as may be desirable for particular applications. It should be noted, however, that in at least these embodiments, the power and thus recharging of the battery 156 is provided via an engagement with the audio jack 140 and not via a separate and distinct power plug located on the body or case 110 of the device itself.

Returning now to FIG. 8, the remaining components of the alcohol detection device 100, namely the audio jack 140, the associated slide mechanism 170, and the further associated switch 158 are illustrated. The audio jack 140 according to various embodiments is positioned such that an end portion thereof may be moved through opening 120 (see FIG. 6A). In certain embodiments, the audio jack 140 comprises a 3.5 mm audio socket with at least two audio channels, a microphone input, and a ground wire, all as may be seen in FIG. 9. As will be described in further detail below, communication between the mobile device 200 and the alcohol detection device 100 may be configured to be performed via the audio jack 140. In such embodiments, the microphone input may be configured to receive data from one or more tests performed by the alcohol detection device 100 and to transmit the same to the mobile device 200 (e.g., see “microphone input: transmitter TX” of FIG. 9). In a similar fashion, one of the two audio channels may be configured according to these and still other embodiments to transmit data to the alcohol detection device 100 from the mobile device 200 (e.g., see “stereo right channel: receiver RX” of FIG. 9). The remaining one of the two audio channels is not, according to certain embodiments, configured to send or receive data, but may be configured to charge the alcohol detection device's battery, as described elsewhere herein (e.g., see “stereo left channel: charge +5V input” of FIG. 9). It should be understood, however, that a variety of audio jack 140 configurations may be provided that may differ minimally or substantially relative to the configuration described above, without departing from the scope and nature of the various embodiments described herein, to the extent that such at least provide at least one-directional transmission of data between the devices 100 and 200.

FIG. 8 further illustrates the slide mechanism 170, which is configured according to various embodiments to facilitate movement of the audio jack 140 from a first position or orientation (see position 170A of FIG. 6A) to a second position or orientation (see position 170B of FIG. 6B) and vice versa. In at least the illustrated embodiment, such movement is provided at least in part by a clip portion 172 and a tab portion 174 of the slide mechanism 170. According to various embodiments, the clip portion 172 of the slide mechanism 170 is configured to operatively engage a base portion (shown but not numbered) of the audio jack 140. In at least the illustrated embodiment, the clip portion 172 comprises an annular-shaped ring of “fingers” that substantially mate with corresponding grooves on the base portion of the audio jack 140 so as to secure and retain both elements relative to one another. It should be understood, however, that any of a variety of clip portions 172 may be incorporated within the slide mechanism 170, beyond that illustrated, provided such maintains an operative connection between the same and the audio jack 140 so as to impose movement upon the latter, when desirable by a user.

The tab portion 174 of the slide mechanism 170 illustrated in FIG. 8 is configured according to various embodiments such that it is both operatively connected to the clip portion 172 of the slide mechanism and extends beyond an external surface of the body or case 110 of the alcohol detection device 100. In certain embodiments, the tab portion 174 extends at least partially through the elongate slot 125 located on the bottom surface of the alcohol detection device 100, as previously described herein with reference to at least FIGS. 6A-B. It should be understood with reference to FIG. 8 in conjunction with FIG. 6A-B that the tab portion 174 of the slide mechanism 170 has a length substantially less than a length of the elongate slot 125, such that the tab portion may be translated along the length, when such movement is desirable by a user of the device 100.

With particular reference to FIGS. 6A & 8, the tab portion 174 may be slid adjacent a first end of the elongate slot 125, such that the slide mechanism 170 and the audio jack 140 are in the first position or orientation 170A. In the first position or orientation 170A according to various embodiments, the audio jack 140 is configured to be fully retracted within the interior of the body or case 110 of the device 100, thereby contributing to the sleek and smooth lines thereof, as mentioned previously. In the second position or orientation 170B, as may be seen in FIG. 6B, according to various embodiments the audio jack 140 is configured to be fully extended beyond the exterior surface of the body or case 110 of the device 100, thus facilitating connection thereof to an associated mobile device 200 (or charging cable or even another device, as may be desirable by particular users thereof).

It should be understood that in the second position or orientation 170B, the audio jack 140 may be further configured in certain embodiments to activate (e.g., turn on) the alcohol detection device 100 based upon movement into such position or orientation. In certain embodiments, a switch 158 (see FIG. 8) may be configured substantially adjacent the audio jack 140, such that translational movement of the audio jack from the first position or orientation 170A and into the second position or orientation 170B manipulates the switch 158 so as to activate at least certain components within the alcohol detection device 100. In at least the illustrated embodiment, the switch 158 is configured such that extending the audio jack 140 into the second position or orientation 170B moves the switch upward, so as to engage one or more power-associated contacts, thereby providing a “power-on” signal to the alcohol detection device 100.

The audio jack 140, slide mechanism 170, and/or switch 158 may, however, be configured, shaped, and/or positioned otherwise, as may be desirable for certain applications. Indeed, in at least one embodiment, wherein data and test results are transmitted wirelessly from the device 100 to one or more other associated devices, the audio jack 140 and associated components may be dispensed with entirely, but for purposes of charging the device 100, as will be described in further detail below. Still further, in these and other embodiments, alternative and/or additional components may be provided within the alcohol detection device 100 for purposes of charging the same, thereby permitting elimination of the audio jack 140 in its entirety, should such be desirable, for example where communication between the device 100 and an exemplary mobile device 200 or application 230 (described below) may be performed wirelessly. Exemplary, non-limiting wireless communication protocols, as previously described herein, may include 802.11, GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol including near-field communication techniques and procedures.

Overall, although various internal and external components of the alcohol detection device 100 have been described herein, it should be understood that one or more may be thus altered, whether minimally or substantially, relative to those embodiments described herein, without departing from the scope and nature of the present invention. Thus, in this regard, the disclosure provided herein should be considered exemplary and non-limiting in nature.

c. Exemplary Mobile Device 200

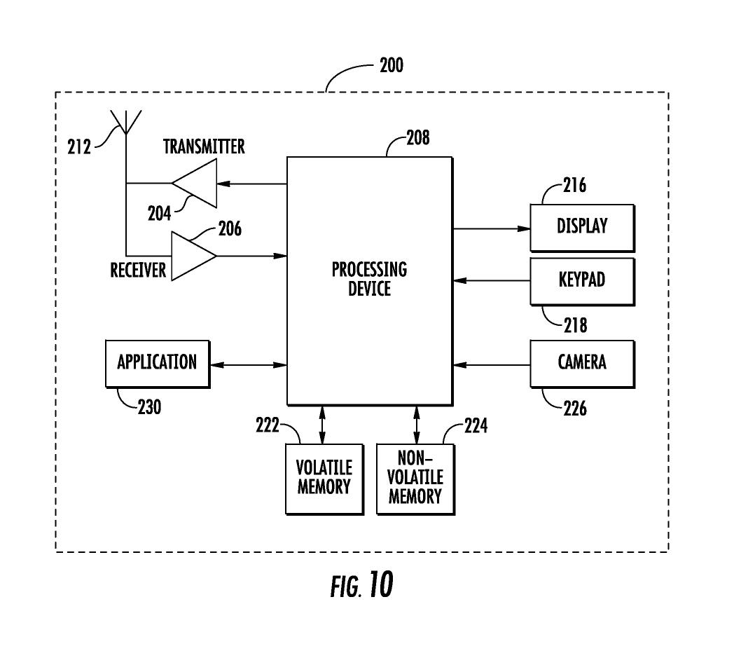

FIG. 10 provides an illustrative schematic representative of a mobile device 200 that can be used in conjunction with various embodiments. Mobile devices 200 can be operated by various parties, including the non-limiting examples of individuals for personal use and employees during the course of performing their job duties. As shown in FIG. 10, a mobile device 200 can include an antenna 212, a transmitter 204 (e.g., radio), a receiver 206 (e.g., radio), and a processing element 208 that provides signals to and receives signals from the transmitter 204 and receiver 206, respectively. The processing element 208 may also be referred to as one or more processors, processing circuitry, and/or similar terms used herein interchangeably, such as CPLDs, microprocessors, multi-core processors, co-processing entities, ASIPs, microcontrollers, and/or controllers.

The signals provided to and received from the transmitter 204 and the receiver 206, respectively, may include signaling data in accordance with an air interface standard of applicable wireless systems to communicate with various entities, such as one or more alcohol detection devices 100, one or more central servers 10, one or more centralized computing devices 15, one or more Global Positioning System (GPS) satellites 20, and/or the like, whether via the one or more networks 25 described elsewhere herein or otherwise. In this regard, the mobile device 200 may be capable of operating with one or more air interface standards, communication protocols, modulation types, and access types. More particularly, the mobile device 200 may operate in accordance with any of a number of wireless communication standards and protocols. In a particular embodiment, the mobile device 200 may operate in accordance with multiple wireless communication standards and protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile device 200 can communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The mobile device 200 can also download changes, add-ons, and updates, for instance, to its firmware, software (e.g., including executable instructions, mobile applications 228, program modules), and operating system.

According to one embodiment, the mobile device 200 may include a location determining device and/or functionality. For example, the mobile device 200 may include a GPS module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites. In certain embodiments, such data may be used to, at least in part, provide location-related data to users of the system, for example including indications of nearby taxis, taxi services, restaurants, hotels, and the like. Such data, as will be described in further detail below, may be provided to a user of the mobile device 200 via a display, whether in graphical or textual format.

The mobile device 200 may also comprise a user interface (that can include a display 216 coupled to a processing element 208) and/or a user input interface (coupled to a processing element 208). The user input interface can comprise any of a number of devices allowing the mobile device 200 to receive data, such as a keypad 218 (hard or soft), a touch display, voice or motion interfaces, a camera 226, or other input device. In embodiments including a keypad 218, the keypad can include (or cause display of) the conventional numeric (0-9) and related keys (#, *), and other keys used for operating the mobile device 200 and may include a full set of alphabetic keys or set of keys that may be activated to provide a full set of alphanumeric keys. In embodiments including a camera 226, the camera can be configured to capture user data for verification and/or analysis in conjunction with alcohol test results, as will be described in further detail below. In any of these and still other embodiments, it should be understood that, in addition to providing input, the user input interface can also be used, for example, to activate or deactivate certain functions, such as screen savers and/or sleep modes.

The mobile device 200 can also include volatile storage or memory 222 and/or non-volatile storage or memory 224, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database mapping systems, data, applications, programs, program modules, scripts, source code, object code, byte code, compiled code, interpreted code, machine code, executable instructions, and/or the like to implement the functions of the mobile device 200.

According to various embodiments, a mobile application 230 is provided on the mobile device 200 described elsewhere herein. In certain embodiments, a user of the alcohol detection device 100 may be required to download and install the mobile application 230, as such processes are commonly known and understood in the art, prior to use of the device 100. In at least one embodiment, as will be described in further detail below, the mobile application 230 may be configured to analyze a frequency received from the alcohol detection device 100 as a component of test generated data (i.e., test data) and to subsequently convert such back to a voltage, which is then converted to a BAC reading (i.e., formatted data). In another embodiment, also described below, the mobile application 230 may be configured to receive a voltage (i.e., a component of test data) from the alcohol detection device 100 wirelessly and to subsequently convert such to a BAC reading (i.e., formatted data). In still other embodiments, the mobile application 230 may not necessarily perform any analysis upon received test results and be configured instead to receive, whether via the audio jack 140 or via a wireless network connection (e.g., Bluetooth, and the like), a fully processed BAC reading (i.e., both test data and formatted data) from the alcohol detection device 100 itself. Still other variations may exist, and as such it should be understood that the configurations of the mobile application 230 described herein are for exemplary purposes only and should not be construed as limiting in scope upon the present invention.

With reference specifically to those embodiments in which the mobile application 230 may be configured to perform at least some portion of data analysis and/or conversion upon transmissions received from the alcohol detection device 100, where transmission occurs via the audio jack 140 of the device, a couple of different approaches exist. In one exemplary embodiment, as mentioned, upon conversion of airflow through the device 100 to a signal, such signal, provided in audio form and at an appropriate frequency (e.g., 0-22 KHz), may be directly transmitted to the mobile device 200 via the audio jack 140. The mobile application 230, in such embodiments, is correspondingly configured to receive the audio frequency signal and upon receipt thereof convert the same to a voltage, which is in turn converted into a BAC reading. In another exemplary embodiment, however, the audio frequency signal may be substituted with a transmission of Manchester encoded data, as such (like the audio frequency signal) may be configured to eliminate any DC-voltage values that are unsupported by conventionally known and used audio interfaces within mobile devices 200.

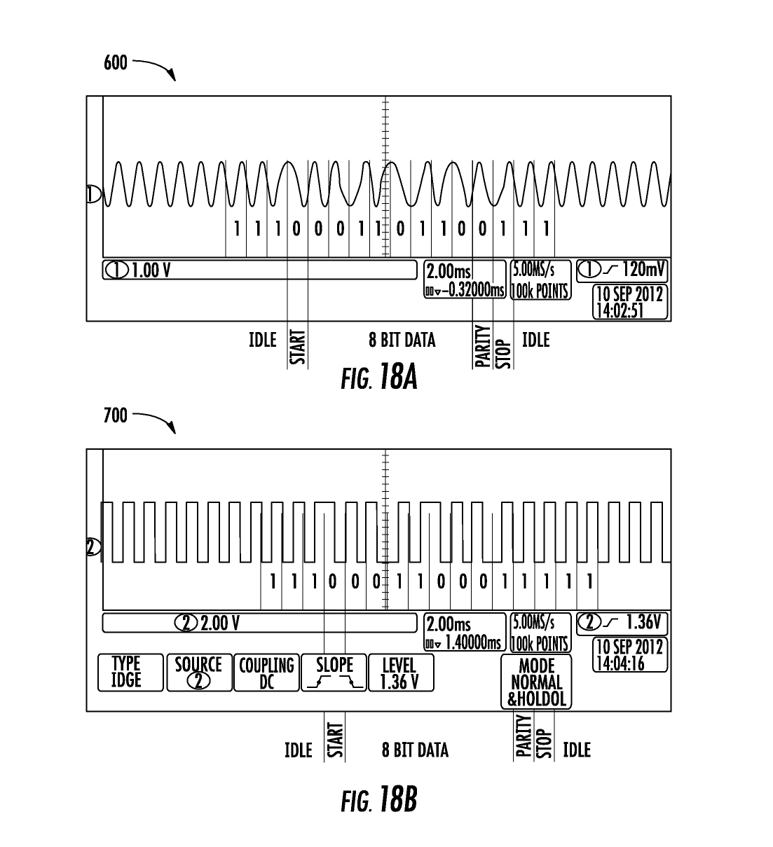

In those embodiments incorporating a transmission of Manchester encoded data to the mobile application 230 via the audio jack 140 of the alcohol detection device 100, such may be configured for transmission in a universal asynchronous receiver/transmitter (UART) fashion, incorporating start-, parity-, and stop-bit components. In particular, in these embodiments, Manchester encoding works by replacing every 1 in the data stream with 01 and every 0 with 10, as may be seen in at least FIG. 18A. This encoding doubles the amount of bits transferred, but it ensures on average a DC-level of zero, thus complying with the requirements of various audio interfaces, as commonly known and in existence within mobile devices 200.

With particular reference to FIG. 18A, one byte of transmitted data from a mobile device 200 to the alcohol detection device 100 is illustrated in display 600, as may be generated according to various embodiments described herein. It may be understood from this figure that the rising edge represents a value of 1, whereas a falling edge of the transmission represents a 0. The transmission further includes start-, stop-, and parity bit, just as would be expected via a UART serial data transmission, as such are typically configured and known in the art. In a similar fashion, an exemplary one byte of transmitted data from the alcohol detection device 100 and to the mobile device 200 is illustrated in FIG. 18B. Such data transmission is likewise Manchester encoded, but may be in at least certain embodiments encoded as a square wave signal (versus the sinusoidal wave signal of FIG. 18A). Amongst various benefits, the square wave signal is relatively easier to generate with a microcontroller, as may be found within various embodiments of the alcohol detection device 100, as previously mentioned. In at least this embodiment, the square wave signal is low-pass filtered and AC coupled before it is passed through the microphone input of the mobile phone 200.

In still other embodiments, data transmission between the alcohol detection device 100 and the mobile phone 200 may occur via any of a variety of wireless networks, as such have been previously described herein. In one embodiment, as a non-limiting example, the devices 100 and 200 may be configured to exchange data via a Bluetooth connection, as such is commonly known and understood in the art to entail. In other embodiments, any of a variety of data exchange connections may be provided between devices 100 and 200, as may be desirable for particular applications, whether wireless or otherwise. In this regard, it should also be understood that any of a variety of data transmission modes and processes for encoding, decoding, encrypting, decrypting, and/or otherwise exchanging the same may be provided as between the mobile device 200 and the alcohol detection device 100 described herein, as may be beneficial and/or advantageous for specific applications. In this manner, the exemplary configurations described herein should be considered non-limiting in nature and are provided for purposes of a complete and thorough disclosure thereof.

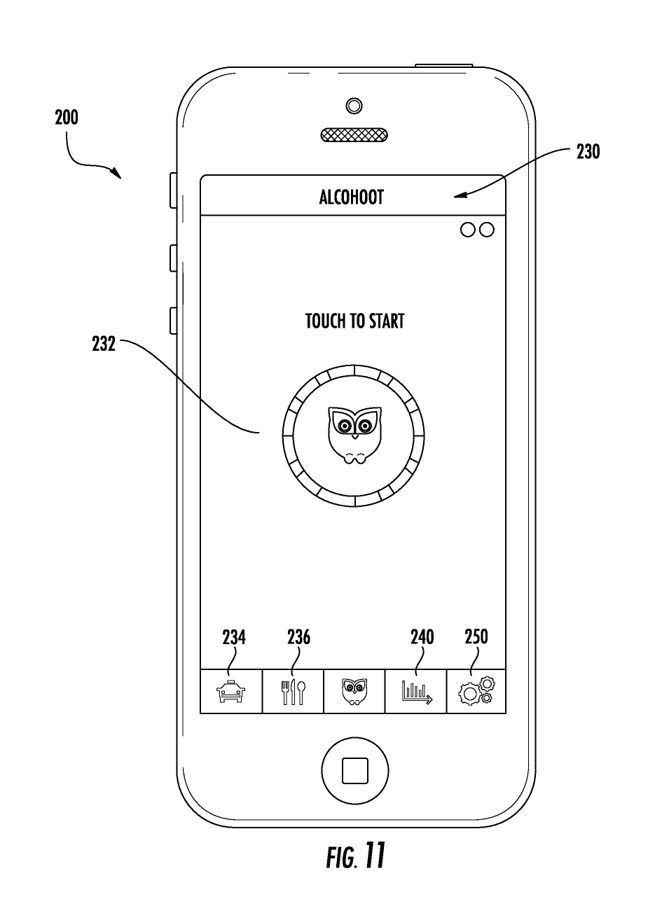

With this context, FIGS. 11-15 illustrate various display screens of an exemplary mobile application 230 that may be utilized upon a mobile device 200 according to various embodiments described herein, upon receipt of and to likewise facilitate the receipt of and subsequent handling of test result data. FIG. 11 in particular illustrates an exemplary home screen display 232 of the exemplary mobile application 230 that may be provided according to various embodiments. As may be seen, a touch screen interface may be utilized so as to “start” or activate the application so as to implement a test in conjunction with the alcohol detection device 100. Additional menu items, otherwise referred to herein as post-test options may also be provided on the exemplary home screen display 232, which may include non-limiting exemplary icons for taxi service 234, restaurant service 236, historical data 240, and miscellaneous settings 250. Additional screen displays, associated with these icons will be described, in turn, below; however, it should be understood that any combination of icons may be provided on analogous home screen displays 232, as may be desired for additional and/or alternative capability and functionality of the mobile application 230.

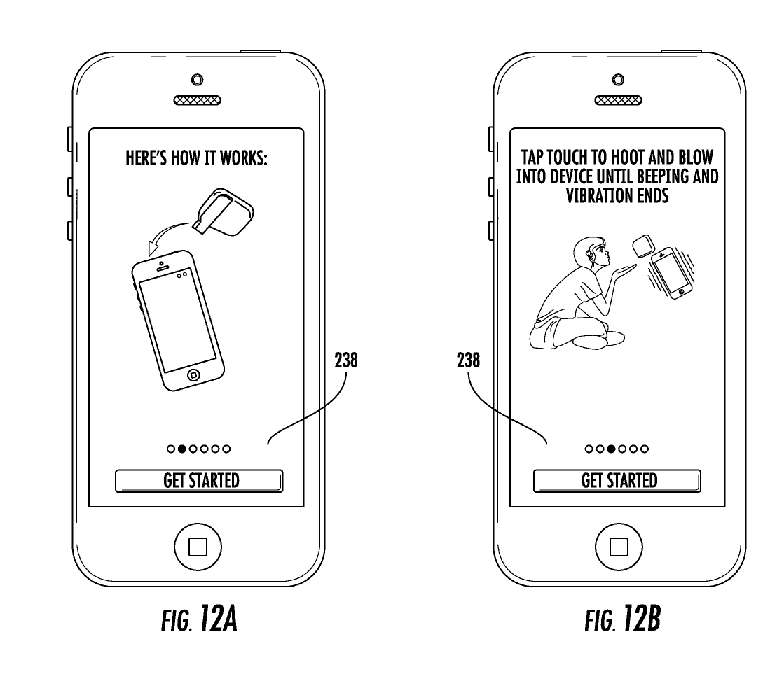

Before turning to the icons 234, 236, 240, and 250, as mentioned, it should be noted that FIGS. 12A-B further illustrate various embodiments of an exemplary user tutorial 238, as may also be provided within the mobile application 230 according to various embodiments thereof. As illustrated, the tutorial 238 may be configured to instruct users on how to use the alcohol detection device 100, not only as a stand-alone product, but also when operatively connected to the mobile phone 200. Still further, a variety of instruction screens may be provided, informing users how to perform a text with the device 100, for example, as illustrated to “Tap Touch to Hoot and blow into device until the beeping and vibration ends,” which is designed to inform a user how to conduct a complete and accurate airflow text using the device 100. Various features and any of a combination of instructions with respect to the same may also be provided within the user tutorial 238, as may be desirable of advantageous for particular applications, although only two exemplary illustrations thereof appear in FIGS. 12A-B.

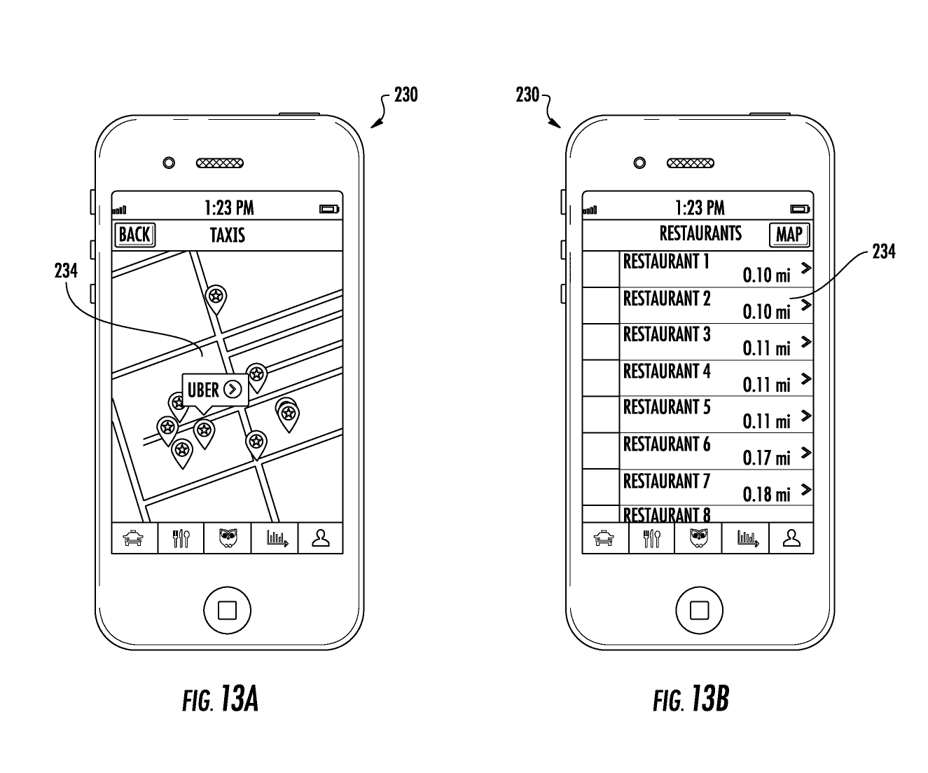

Turning now with reference to FIG. 13A, an exemplary taxi service 234 screen display is illustrated, as may be accessed from the taxi service icon, as may be located on a home screen display or another interface of the mobile application 230. As may be seen, a user of the mobile application 230 may, for any of a variety of reasons, wish to know the nearest available taxi services. Such may be in response to obtaining test results via the alcohol detection device 100 that would place the user's BAC level above a legal limit for personally operating a motor vehicle, although alternative scenarios may be envisioned. As seen in FIG. 13A, nearby taxi services 234 may be presented to the user of the mobile application 230. In at least the illustrated embodiment, the results are provided in a graphical map interface, even identifying thereon the location of the user themselves. It should be understood that any of a variety of display formats may be provided, whether in a list or otherwise, and additional information regarding each service (e.g., a phone number therefor) may also be displayed and/or accessible from the taxi service 234 screen display. Any of a variety of transportation or even alternative service provider entities may be likewise displayed, in addition to or instead of taxi service data in these and still other embodiments.

FIG. 13B illustrates an analogous restaurant service 236 screen display, as may be accessed from the restaurant service icon of the mobile application 230. As may be seen, a user of the mobile application 230 may, for any of a variety of reasons, wish to know the nearest available restaurants. Such may be in response to obtaining test results via the alcohol detection device 100 that would place the user's BAC level above a legal limit for personally operating a motor vehicle, in response to which the user may wish to go to a restaurant to “sober up” (whether by eating food therein or simply waiting for a sufficient period of time for the effects of any consumed alcohol to diminish), although alternative scenarios may be envisioned. In any case, as seen in FIG. 13B, upon request (or automatically as described elsewhere herein) a user of the mobile application 230 may be presented with a list (or a graphical or map-based display) of nearby restaurants. As with the taxi service feature, additional information regarding the restaurant may also be displayed, including the non-limiting examples of addresses, distances, ratings, and phone numbers therefor. Still further, as with the taxi or transportation service feature, the restaurant service 236 feature may be configured to include details regarding coffee shops, retail stores, gas stations, hotels, and any of a variety of service providers, as may be desirable for particular applications and as should be considered within the scope of the various embodiments of the present invention described herein.

It should further be understood that although the taxi and restaurant service features of the mobile application 230 have been described herein as accessible by a user via selection of one or more icons to initiate the display thereof, such service features (and still others) may be alternatively and/or additionally configured to automatically display upon receipt of a BAC level reading above a legal limit (or above a user-defined threshold). In such embodiments, the service feature displays may be configured to automatically display by default; in other embodiments, however, the displays automatically provided may be configured according to one more parameters and/or device settings pre-established by a user of the mobile device 200 and the mobile application 230.

Although FIGS. 13A-B illustrate exemplary taxi and restaurant service features and associated display screens, as may be provided within mobile application 230, it should be understood that any of a variety of analogous display screens and associated data and/or information may be provided, as may be desirable for a particular user, for a particular market segment of users, or based on any of a variety of factors. Non-limiting examples may include screen displays and/or icons to facilitating any combination of the following: (1) posting of result data (or any information associated with the mobile application 230 and/or the alcohol detection device 100) to social media websites (e.g., Facebook, Myspace, Instagram, Tumblr, Twitter, Snapchat, Reddit, and the like); (2) sending results with or without a picture (e.g., as may be taken via a camera 226 (see FIG. 10) located on the mobile device 200) via email, text, WhatsApp, other syndicated applications, and the like); (3) adding notes to annotate test results (e.g., as may be useful for police applications at checkpoints or otherwise); (4) calling a pre-determined friend to seek assistance; (5) texting a pre-determined friend to seek assistance; (6) blocking texting and calling (and other mobile device features) upon receipt of a BAC level above a particular limit; (7) assessing local laws and regulations related to BAC levels, determined at least in part based upon GPS-related information obtained via the satellites 20 described elsewhere herein and the mobile device's functionality; and (8) uploading at least a portion of test result data and/or additional data to a central server (as described elsewhere herein) and/or to a cloud computing server for storage and maintenance thereon. Indeed, any of a variety of data exchange and sharing mediums, modes, and scenarios may be provided via the mobile application 230 described herein without departing from the scope and nature of the present invention.

Beyond the above-described “data sharing” capabilities that may be provided within certain embodiments of the mobile application 230 described herein, additional functionality may also be provided for verification and reporting of at least test result data, where such may be desirable for particular applications. For example, the mobile application 230 may incorporate any combination of fingerprint, face, voice, or DNA recognition features, as may be useful for verifying the identity of the person taking the test on the alcohol detection device 100 associated with the particular mobile device 200. Such features would ensure that third parties taking tests on a particular user's mobile device 200, whether unbeknownst to the user or otherwise, would be stored and handled separately and distinctly from any tests and results tied to the user themselves.

Still further capabilities of the mobile application 230, as may be provided according to various embodiments in conjunction with the mobile device 200 upon which such is contained may include non-limiting examples of: (1) transmitting and saving results to a police database of license plates; (2) associating and/or transmitting results for individuals on probation to at least their probation officers; and (3) transmitting and saving results for parental reference, where the devices 100, 200 may be provided to a young driver remaining under the supervision of such parents. It should be understood that any of a variety of exchanges and storage (and even backup) of data may be provided and/or facilitated via the mobile application 230, as may be desirable for particular applications and those examples provided herein should be considered non-limiting in nature.

The mobile application 230 according to various embodiment may be further and/or alternatively configured to, beyond sharing, transmitting, and storing data via a variety of mediums, whether wirelessly or otherwise, further disable various capabilities in response to receiving a BAC level test result above a pre-determined threshold. For example, where a BAC level test result exceeds the legal limit to operate a motor vehicle in the jurisdiction where the device is presently located, the mobile application 230 may be configured in certain embodiments to communicate with an ignition interlock device upon the user's motor vehicle, so as to, via the communication, prevent operation of the motor vehicle based at least in part upon the test result. In certain embodiments, a countdown screen may be displayed for a user in conjunction with such a feature (or otherwise), informing a user based upon personal data (e.g., weight, height, sex, and the like) how many minutes must elapse until their BAC level is estimated to no longer exceed the pre-determined threshold. In those and other embodiments, an additional test may be required so as to override the previous interlock of the ignition of the motor vehicle.

Analogous interlocking features may be provided via the mobile application 230 with respect to a variety of devices beyond motor vehicles, whether on the mobile device itself (e.g., blocking of texting when above a certain BAC level) or associated with a device other than the mobile device and/or the alcohol detection device. Still further, various embodiments, beyond the conventionally understood mobile device 200 in its form as substantially a mobile phone may also be envisioned, upon which the mobile application 230 may be downloaded and used. Such may include non-limiting examples of tablets, law enforcement handheld devices, medical devices, and the like.

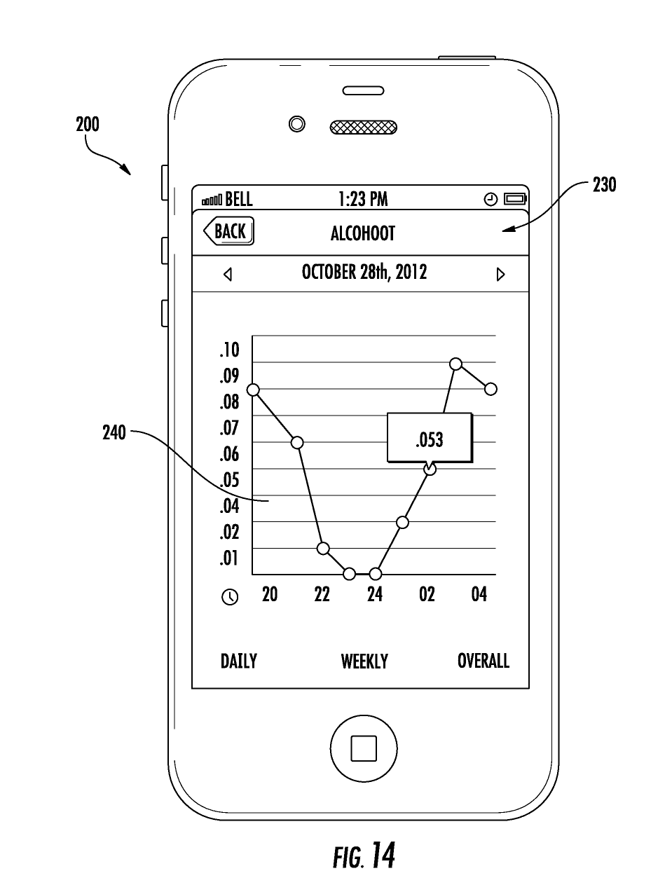

Turning now to FIG. 14, various embodiments of the mobile application 230 may further be configured to, upon request therefor, generate one or more screen displays 240 detailing historical data associated with tests conducted on a particular alcohol detection device 100 and/or under a particular user's pre-established profile (e.g., an account for use of the application upon the mobile device 200). In this manner, historical data may be maintained, viewed, analyzed, and even shared (in any of the manners previously described), as may be desirable for particular applications or by particular users. Although illustrated as a graphical chart in FIG. 14, it should be understood that any of a variety of graphical, textual, or otherwise human-readable formats and interfaces may be used for purposes of displaying historical data accumulated by the mobile application 230. Trends, whether weekly or yearly or otherwise, may also be viewed and/or analyzed, as may be desirable.

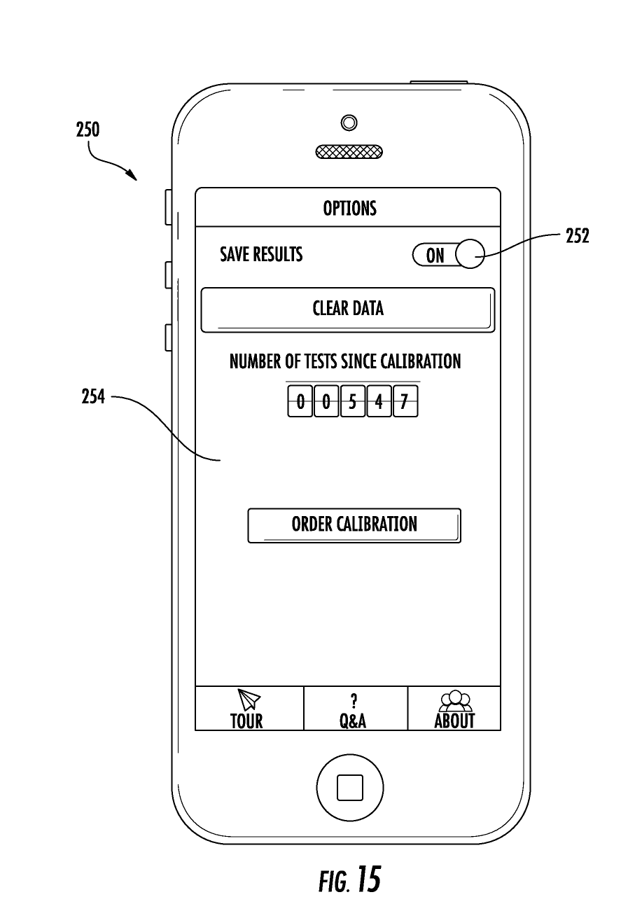

Notably, in certain instances, the above-described historical data accumulation may raise privacy concerns for certain users. As a result, according to various embodiments, the mobile application 230 may be provided within a miscellaneous settings feature 250 with the capability to, for example, toggle on or off the “result saving” feature or features. Customization, although not illustrated in FIG. 15, may also be possible in certain embodiments, permitting retention of data for a particular number of results, a particular duration of time, or otherwise. In at least one embodiment where results are required to be shared with law enforcement (or other) personnel, based upon the identity of the user of the device and application, it should be understood that such options to “clear data” or otherwise delete test results may be disabled within the mobile application, as may be desirable in such applications.

Still further, with continued reference to FIG. 15, it should be understood that according to various embodiments the mobile application 230 may be configured with a screen display 254 and an associated counter that monitors whether calibration is necessary for the associated alcohol detection device 100. In certain embodiments, calibration may be necessary every few hundred tests, although in other embodiments, calibration may be necessary much less or much more often. In still other embodiments, calibration may be based upon internally perceived and/or user perceived inaccuracies within test results over a particular period of time, whether predetermined or otherwise.

d. Exemplary Communication Protocols Between Devices 100 & 200

Having described above a variety of modes via which communication between the alcohol detection device 100 and the mobile device 200 may occur, the various communication protocols associated therewith so as to provide the functionality described elsewhere herein must also be considered. As a non-limiting example, in certain embodiments, as mentioned, extending the audio jack 140 may be configured so as to automatically provide a “power-on” signal to the device 100. In other embodiments, such a “power-on” signal may only be generated if the device 100 is further operatively connected to an associated mobile device 200. A variety of combinations and conditions for the exchange of data and for operation of the alcohol detection device 100 may be provided; as such, those described herein-below should be considered non-limiting and as being provided for purposes of disclosure thereof only.

Thus, according to various embodiments, exemplary and non-limiting incoming commands to the alcohol detection device 100 may comprise at least the following:

| INDEX | name | code | Explanation |
|---|---|---|---|
| 1 | ready | 00000001 | When the application on the mobile device is ready, it sends a |
| | | | ready command to the alcohol device and waits until the alcohol |
| | | | device sends a ready command in response. |
| | | | This command may be sent at any stage of the device's operation, |
| | | | and the alcohol device will respond according to its state at that |
| | | | moment. The aim is to find out if there is a problem in |
| | | | communication and if the device is disconnected for some reason |
| | | | and to act accordingly. |
| 2 | start test | 00000010 | A command that the application sends to the alcohol device to |
| | | | start the process of the alcohol level testing. |
| 3 | test result request | 00000011 | A command that the application sends to the alcohol device in |
| | | | request for the last alcohol test result. |
| 4 | battery status | 00000100 | A request to send the current battery charge status. |
| | request | | |
| 5 | number of tests | 00000101 | A request to send the number stored in the test counter of the |
| | since last | | alcohol device. |
| | calibration | | |
| | request | | |
| 6 | Calibration | 00000110 | A command to switch the alcohol device to calibration mode. The |
| | command | | calibration process will also reset the test number counter. |
| 7 | Turn Off | 00000111 | This command will tum off the alcohol device. |
| 12 | Charge | 00001000 | In case the device is connected to an application, this means it is |
| | | | connected physically to a mobile device; it will have to receive a |
| | | | specific command that will allow a charging process. |
| 13 | Stop charge | 00001001 | In case the device is connected to an application, this means it is |
| | | | connected physically to a mobile device; it will have to receive a |
| | | | specific command that will stop a charging process. |

According to various embodiments, it should be understood that Index #1 above, the command sent to the alcohol detection device 100 indicating that the mobile application 230 is ready to commence a test may be provided periodically, upon query regarding status from a user of the mobile device 200, or automatically. Where provided and transmitted automatically, in at least one of such embodiments, the mobile application 230 may be configured to automatically transmit the command to the alcohol detection device upon connection therewith, for example upon insertion of the audio jack 140 of the alcohol detection device 100 within an associated port on the mobile device. In still other embodiments, the “ready” command may also be configured to turn on the alcohol device, where such does not occur otherwise, for example via sliding of the audio jack 140 into a second position 170B, as previously described herein. In at least one embodiment, the “turn on” or “ready” command may be transmitted upon receiving of any other communication signal from the mobile application 230 to the alcohol detection device 100, versus a separately transmitted signal or command. Indeed, various alternatives may also be provided in yet other embodiments, as may be desirable for particular applications.

With regard to Index #2, wherein a command is sent from the alcohol detection device 100 by the mobile application 230 so as to instruct commencement of a test, it should be understood that such command may be varied such that it instructs a user when to breath into the device 100. For example, the alcohol detection device 100 may, according to various embodiments be configured such that it remains in a stand-by mode at all times, thus ready to commence testing at any time. In such embodiments, the “start test” command from the mobile device 200 may thus be configured to provide some sort of visual and/or audio indication to the user that testing may be commenced as such indicators have been previously described herein.

According to various embodiments, a “calibration command” (Index #6) may be transmitted to the alcohol detection device 100 by the mobile application 230, as described previously herein with respect to FIG. 15. As mentioned, such may be configured for automatic recurrence, or upon user-initiation thereof. Similarly, in these and other embodiments, with respect to the “turn off” command (Index #7), such may be transmitted automatically and concurrently with disconnection of the mobile phone 200 from the alcohol detection device 100. In still other embodiments, the “turn off” command may be transmitted after a pre-determined period of inactivity, whether with respect to testing or simply communication between the devices 100 and 200.

It should be noted with respect to the above-described exemplary command configured to be sent by the mobile application 230 to the alcohol detection device 100, where such have been referenced by specific binary codes, such codes are associated with those embodiments described previously herein incorporating Manchester encoding of data transmissions. In other embodiments, such codes may be replaced with analogous signals or wireless transmissions, which admittedly may also be coded in alternative manners, as may be necessary for preserving similar distinctions there-between. That being said, the binary codes provided above (and below with respect to commands sent by the alcohol detection device 100) should be considered exemplary and thus non-limiting in scope.

With that context, exemplary and non-limiting outgoing commands from the alcohol detection device 100 may similarly, according to various embodiments, comprise at least the following:

| INDEX | name | code | Explanation |
|---|---|---|---|
| 1 | ready | 00000001 | When the alcohol device is turned on and is ready to operate, it |
| | | | sends a ready command in response to a ready command from |
| | | | the software. |
| 2 | testing | 00000010 | When a user starts to blow air into the device. |
| 3 | test end | 00000011 | When the testing process is finished, the alcohol device sends a |
| | | | test end signal. |
| 4 | test results | 00000100 | The result of the last test. After this word will follow 8 bit binary |
| | | | code representing the testing result |
| 5 | battery status | 00000101 | The current charge status of the battery. |
| | | | After this word will follow 8 bit binary code representing the battery |
| | | | status |
| 6 | number of tests | 00000110 | The number of tests stored in the tests counter. |
| | since last | | After this word will follow a binary code representing the number of |
| | calibration | | tests since last calibration |
| 7 | Calibration | 00000111 | Calibration success |
| | success | | |
| 8 | Calibration failure | 00001000 | Calibration failure |
| 9 | Power off | 00001001 | Powering off the devise |
| 10 | Ready fail | 00001010 | In case of a known problem, a command that indicates failure to |
| | | | go into the ready state. |
| 11 | Testing fail | 00001011 | The testing process failed. |
| 12 | Tec fail | 00001100 | An unresolved error. |

According to various embodiments, a “testing” command may be transmitted to at least the mobile application 230 upon detection of air being blown into the device 100. In certain embodiments, such command may be configured to initiate further command, such as the non-limiting examples of providing audio/visual indicators to a user that testing must continue, for example where vibration and/or beeping and/or flashing light indicators may be configured to occur throughout the duration of a test, ceasing upon completion thereof. In at least one embodiment, such indicators may be further configured to actually notify the user that they may stop blowing air into the device at that point. Of course, various alternatives may be provided, as may be desirable for particular applications in this regard.

Still further, in association with the “calibration command” transmitted to the alcohol detection device 100 by the mobile application 230, as described previously herein, the alcohol detection device may be similarly configured, but to notify the application 230 of either successful or failed calibration attempts, as the case may be. Similarly, power on and power off commands may be transmitted, whether automatically, upon occurrence of an event (e.g., no activity or communication for a particular time period—for example 60 seconds), or otherwise. Test result commands, along with successful and failed test indicators may also be communicated, along with associated commands, as illustrated above.

That being said, as with the various exemplary commands described to be transmitted by the mobile application 230, it should be understood that in those embodiments of the alcohol detection device 100 and mobile device 200 described herein whereby test results and/or other commands are communicated in formats other than Manchester encoded binary data strings, whether via frequency signals, voltage signals, any of a variety of wireless transmission modes, or otherwise, the above described “codes” may be configured in alternative fashions, as may be desirable and/or necessary for particular applications.

### III. Exemplary System Operation

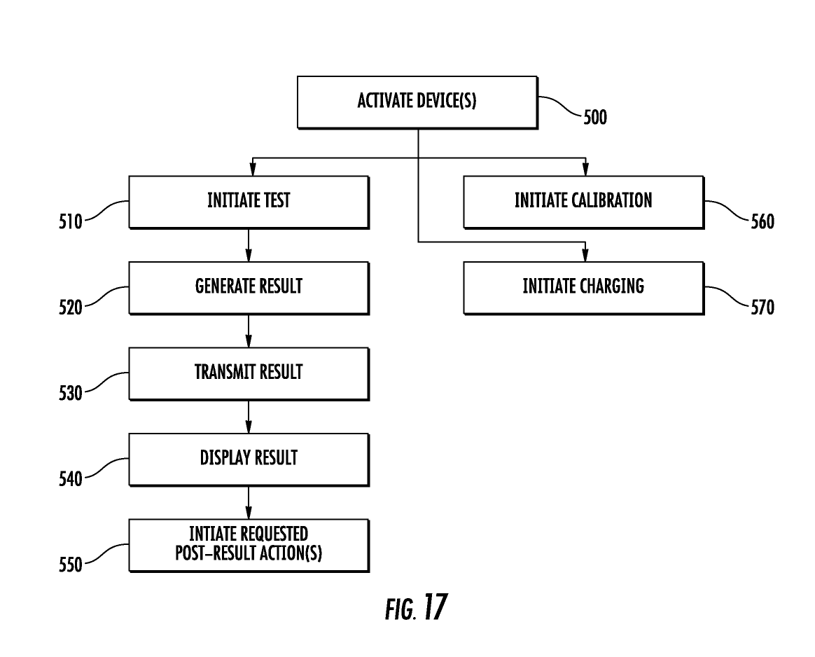

Reference will now be made to FIG. 17, which illustrates an exemplary flowchart illustrating operations and processes that can be used in accordance with various embodiments of the present invention, along with FIGS. 11-15, which provide exemplary screen shots of the mobile application 230 described elsewhere herein, to the extent such provides context to the operation and processes performed by the system and via the alcohol detection device 100 and the mobile device 200 beyond that which as previously described herein. Generally speaking, it should be noted that the system operation and the variations thereof as described herein are exemplary and non-limiting in nature, and as should such not be construed in any manner so as to restrict the scope of the disclosure contained herein. With that in mind, it should be understood that in certain embodiments, communication between the alcohol detection device 100 and the mobile device 200 (and its associated mobile application 230) may be via the audio jack of the device 100 when such is operatively plugged into a corresponding port of said mobile device 200. In other embodiments, such communication may be via one or more wireless networks and one or more protocols associated therewith, as described elsewhere herein. In still other embodiments, either device 100, 200 may communicate via various combinations of the audio jack and wireless configurations and/or either device 100, 200 may further communicate, wirelessly or otherwise, with the central server, as such has been described elsewhere herein as well.

a. Exemplary Application for Personal Use

According to various embodiments, the alcohol detection device 100 and an accompanying mobile device 200 may be used by any one of a plurality of users for recreational and/or personal use, as the case may be desirable. In these and other embodiments, the mobile application 230 located on the mobile device 200 may be configured, as mentioned elsewhere herein, to distinctly manage multiple users of a single alcohol detection device 100. Such capability may be provided, for example, via multiple user logins within the single mobile application 230, as described previously. In any event, once logged into the single mobile application 230, an individual user may thus proceed, as illustrated generally in FIG. 17 and described below.

Beginning with step 500, the user may activate one or more of the devices 100, 200. In certain embodiments, such may be done merely by touching a “start” screen display upon the mobile application 230, although it should be appreciated that such will initiate, behind the scenes so to speak, any of a variety of communication commands to be exchanged between the devices 100, 200. In at least one embodiment, the user may activate at least the alcohol device 100 in step 500 by sliding a slide mechanism 170 located on the device 100 such that an audio jack 140 travels in a transverse direction along an elongate slot and into a second position 170B, whereby at least a portion of the audio jack 140 protrudes from the body or case 110 of the device 100 (see FIG. 6B). Activation of the device 100 may, in other embodiments, further require operatively connecting the audio jack 140 to the mobile device 200. In still other embodiments, however, such may not be necessary, for example where data exchanges between the devices 100 and 200 occur wireless or in some manner other than via an associated audio jack connection.

In any event, according to various embodiments, upon activation in step 500, the user may proceed to either of steps 510, 560, or 570, as may be desirable. Where step 560 is desired, calibration of the alcohol detection device 100 may be initiated, whether upon initial activation thereof or otherwise (e.g., upon notification that calibration is necessary, for example via the mobile application 230 interface, as described previously herein). Where step 570 is desired, charging of the alcohol detection device 100 may be initiated. Such may occur via any of the various commands, as previously described herein, via at least one channel of the audio jack 140 of the device 100, or otherwise. The user may further be notified, via the mobile application 230 or otherwise of calibration status and/or charging status, as the case may be.

Where neither calibration nor charging is desired, the user may proceed instead to step 510, whereby a test may be initiated. It should be understood, however, that although not illustrated in FIG. 17, at least charging of the alcohol detection device 100 could conceivably occur concurrently with test-related steps 510-550, as will be described below. During step 510, the user may initiate a test upon the alcohol detection device 100, which should be generally understood to comprise blowing through a nozzle portion thereof, with an accompanying mouthpiece or otherwise. As previously described, according to various embodiments, one or more LEDs, audio indicators, visual indicators, and the like may provide guidance to a user so as to ensure the airflow continues for the duration of a pre-determined testing period and/or that a sufficient airflow is provided. Upon completion of the test, the user may proceed to step 520, as may be prompted by the mobile application 230 and/or the alcohol detection device 100.

During step 520, the alcohol detection device 100 according to various embodiments is configured to generate test results using one or more of a variety of data analysis processes as described previously herein. In any of those embodiments, a BAC level reading is displayed as a final deliverable for the user. Generally such is displayed (see step 540), upon transmittal thereof from the alcohol detection device to the mobile device, as such occurs in step 530. Notably, in certain embodiments, it is the BAC level reading that is transmitted in step 530, while in other embodiments some portion of specially formatted data is transmitted, which may be subsequently converted into the BAC level reading prior to display thereof in step 540.

Upon display of results in step 540, the user may thus proceed to step 550, whereby one or more post-result actions may be requested and/or initiated. Where initiated, such may be automatically provided to a user for consideration, as described elsewhere herein. Such post-result actions may include a variety of services, as previously described herein, although for purposes of clarity, certain exemplary and non-limiting examples may be (1) locating a nearby restaurant to walk to for purposes of sobering up; (2) locating a nearby taxi service to request a ride home; (3) sharing test results on one or more social media sites; (4) sharing (involuntarily or otherwise) test results with one or more third parties as terms of an agreement (e.g., probation); and (5) interlocking a motor vehicle's ignition system in response to a test result exceeding a legal limit for a jurisdiction in which the device 100 is presently located. Additional post-result actions may be provided, again as have been described elsewhere herein.

b. Exemplary Application for Commercial Use

With continued reference to FIG. 17, noting also FIG. 1 for purposes of context, it should be understood that according to various embodiments, the alcohol detection device 100 and the mobile device 200 may be configured to communicate during the operation thereof not only with each other and/or external third party services or websites and the like initiated by the user, but also third party services and/or interfaces that may not necessarily be at the request of the user. In at least one embodiment, mobile application 230 may be configured to further communicate with a centralized server configured to provide employers with oversight over their employees. Such may be particularly beneficial where such employees operate motor vehicles and/or dangerous or heavy equipment on a routine basis. Ensuring those employees are not under the influence of alcohol thus becomes paramount. In other embodiments, post-result actions in step 550 may include communicating test result data or at least a portion thereof to one or more law enforcement entities. Data may be used for purposes of monitoring and enforcing probation violators and ensuring the terms of such probation are adhered to.

In other contexts, the transmitted data may be used to facilitate prosecutions of repeat offenders, even beyond the duration of a probation period. In still other embodiment, data may be uploaded to any of a variety of third party servers and/or “cloud computing” infrastructures, as such are commonly known and understood. Such information may then be accessed, analyzed, and/or further transmitted by any of a variety of authorized parties, which may include the non-limiting examples of auto insurance providers, employers, law enforcement agencies, parents of young drivers insured under their policies, service providers of services such as ignition interlock devices, and the like, however as may be desirable for particular applications. In these embodiments, it should be understood that the mobile device 200 and the alcohol detection device 100 interface and the communication there-between may be substantially the same as that described elsewhere herein for non-commercial based applications thereof, with the primary distinction being with respect to the additional layer of centralized (or cloud) communication to additional parties other than the user of the devices 100 and 200. In this regard, it should also be understood that any of a variety of configurations may be provided, depending on particular needs and desires for certain scenarios.

### IV. Conclusion

Indeed, as has been mentioned previously herein, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An alcohol detection apparatus for use in conjunction with a mobile application resident on a mobile device, said apparatus comprising:
a memory; and
one or more processors configured to:
determine whether at least one communication pathway exists between said apparatus and said mobile application resident on said mobile device;
responsive to a determination that at least one communication pathway exists, generate an indication that said apparatus is ready to facilitate conducting of at least one blood alcohol content (BAC) level test therewith;
capture test data associated with the conduct of at least one BAC level test; and
convert said test data into formatted data, said formatted data being suitable for transmission from said apparatus and to said mobile application via said at least one communication pathway.

2. The apparatus of claim 1, wherein said at least one communication pathway is a wireless network.

3. The apparatus of claim 1, wherein said at least one communication pathway comprises one or more channels of an audio jack of said apparatus.

4. The apparatus of claim 3, wherein said audio jack comprises at least two audio channels so as to provide a two-way communication pathway between said apparatus and said mobile application.

5. The apparatus of claim 1, further configured (a) to detect said conduct of said at least one BAC level test and (b) responsive to said detection, initiate said capture of said test data.

6. The apparatus of claim 1, wherein:
said apparatus further comprises a pump assembly, said pump assembly being configured to capture air within a portion thereof during said conduct of said at least one BAC level test;
said conversion of said test data into said formatted data comprises transforming said captured air into a BAC number.

7. The apparatus of claim 6, wherein said one or more processors are further configured to transmit said BAC number to said mobile application via said at least one communication pathway.

8. The apparatus of claim 7, wherein said at least one communication pathway is at least one of (1) a wireless network or (2) at least one channel of an audio jack of said apparatus.

9. The apparatus of claim 1, wherein:
said apparatus further comprises a pump assembly, said pump assembly being configured to capture air within a portion thereof during said conduct of said at least one BAC level test;
said conversion of said test data into said formatted data comprises transforming said captured air into encoded binary data.

10. The apparatus of claim 9, wherein said one or more processors are further configured to transmit said encoded binary data to said mobile application via said at least one communication pathway.

11. The apparatus of claim 10, wherein said at least one communication pathway comprises at least one channel of an audio jack of said apparatus.

12. The apparatus of claim 1, wherein:
said apparatus further comprises a pump assembly, said pump assembly being configured to capture air within a portion thereof during said conduct of said at least one BAC level test;
said conversion of said test data into said formatted data comprises transforming said captured air into an audio frequency signal.

13. The apparatus of claim 12, wherein said one or more processors are further configured to transmit said audio frequency signal to said mobile application via said at least one communication pathway.

14. The apparatus of claim 13, wherein said at least one communication pathway comprises at least one channel of an audio jack of said apparatus.

15. The apparatus of claim 1, wherein:
said apparatus further comprises a battery and an audio jack; and
said one or more computer process are further configured to recharge said battery via said audio jack.

16. The apparatus of claim 1, wherein:
said apparatus further comprises an audio jack having at least two channels;
a first channel of said at least two channels is configured to receive data from said mobile application; and
a second channel of said at least two channels is configured to transmit data to said mobile application.

17. The apparatus of claim 16, wherein said data received via said first channel comprises at least one of a request to calibrate the apparatus, a request to charge the apparatus, and a request to power-down the apparatus.

18. A computer-implemented method for using an alcohol detection apparatus in conjunction with a mobile application resident on a mobile device, said method comprising the steps of:
determining, via one or more processors, whether at least one communication pathway exists between said apparatus and said mobile application resident on said mobile device;
responsive to a determination that at least one communication pathway exists, activating said apparatus so as to facilitate conducting of at least one blood alcohol content (BAC) level test therewith;
capturing, via said one or more processors, test data associated with the conduct of at least one BAC level test; and
converting, via said one or more processors, said test data into formatted data, said formatted data being suitable for transmission from said apparatus and to said mobile application via said at least one communication pathway.

19. The computer-implemented method of claim 18, wherein said at least one communication pathway is a wireless network and said method further comprises the step of transmitting said formatted data via said wireless network.

20. The computer-implemented method of claim 18, wherein said at least one communication pathway is at least one channel of an audio jack of said apparatus and said method further comprises the step of transmitting said formatted data via said at least one channel.

21. The computer-implemented method of claim 18, wherein said step of converting said test data into said formatted data comprises transforming said captured air into a BAC number and said method further comprises the step of transmitting said BAC number via said at least one communication pathway.

22. The computer-implemented method of claim 21, wherein said at least one communication pathway comprises at least one of (1) a wireless network or (2) at least one channel of an audio jack of said apparatus.

23. The computer-implemented method of claim 18, wherein said step of converting said test data into said formatted data comprises transforming said captured air into encoded binary data and said method further comprises the step of transmitting said encoded binary data via said at least one communication pathway.

24. The computer-implemented method of claim 23, wherein said at least one communication pathway comprises at least one of (1) a wireless network or (2) at least one channel of an audio jack of said apparatus.

25. The computer-implemented method of claim 18, wherein:
said step of converting said test data into said formatted data comprises transforming said captured air into an audio frequency signal;
said at least one communication pathway comprises at least one channel of an audio jack of said apparatus;
said method further comprises the step of transmitting said audio frequency signal via said at least one communication pathway.

26. The computer-implemented method of claim 18, wherein:
said apparatus further comprises an audio jack having at least two channels; and
said method further comprises the steps of:
transmitting said formatted data via a first of said at least two channels; and
receiving data from said mobile application via a second of said at least two channels.

27. The computer-implemented method of claim 26, wherein said data received via said first channel comprises at least one of a request to calibrate the apparatus, a request to charge the apparatus, and a request to power-down the apparatus.

28. The computer-implemented method of claim 27, wherein, upon receipt of at least said request to charge the apparatus, said method further comprises the step of charging a battery of said apparatus via a third channel of said audio jack of said apparatus.

29. A non-transitory computer program product comprising at least one computer-readable storage medium having computer-readable program code portions embodied therein, the computer-readable program code portions comprising:
an executable portion configured for receiving and storing within one or more memory storage areas one or more algorithms;
an executable portion configured for:
determining whether at least one communication pathway exists between said apparatus and said mobile application; and
if said at least one communication pathway exists, activating said apparatus so as to facilitate conducting of at least one blood alcohol content (BAC) level test therewith;
an executable portion configured for capturing test data associated with the conduct of at least one BAC level test; and
an executable portion configured for converting said test data into formatted data, said formatted data being suitable for transmission from said apparatus and to said mobile application via said at least one communication pathway.

30. The non-transitory computer program product of claim 29, wherein said at least one communication pathway is a wireless network and said product further comprises an executable portion configured for transmitting said formatted data via said wireless network.

31. The non-transitory computer program product of claim 29, wherein said at least one communication pathway is at least one channel of an audio jack of said apparatus and said product further comprises an executable portion configured for transmitting said formatted data via said at least one channel.

32. The non-transitory computer program product of claim 29, wherein said converting of said test data into said formatted data comprises transforming said captured air into a BAC number and product further comprises an executable portion configured for transmitting said BAC number via said at least one communication pathway.

33. The non-transitory computer program product of claim 29, wherein said converting of said test data into said formatted data comprises transforming said captured air into encoded binary data and product further comprises an executable portion configured for transmitting said encoded binary data via said at least one communication pathway.
